(19) United States
(12) Patent Application Publication
(10) Pub. No.: US 2020/0028206 A1
(43) Pub. Date: Jan. 23, 2020

(54) SOLID OXYGEN-REDOX NANOCOMPOSITE MATERIALS

(71) Applicant: MASSACHUSETTS INSTITUTE OF TECHNOLOGY, Cambridge, MA (US)

(72) Inventors: Zhi Zhu, Malden, MA (US); Ju Li, Weston, MA (US)

(73) Assignee: MASSACHUSETS INSTITUTE OF TECHNOLOGY, Cambridge, MA (US)

(21) Appl. No.: 16/061,441

(22) PCT Filed: Dec. 13, 2016
(86) PCT No.: PCT/US16/66338

§ 371 Date: Jun. 12, 2018

Related U.S. Application Data
(60) Provisional application No. 62/266,783, filed on Dec. 14, 2015.
(60) Provisional application No. 62/360,909, filed on Jul. 11, 2016.

(51) Int. Cl. H01M 10/0525; H01M 4/38; H01M 4/131

(52) U.S. Cl. CPC H01M 10/0525; H01M 2004/027; H01M 4/131; H01M 4/38

(57) ABSTRACT

A solid oxygen-redox nanocomposite material including an alkali metal oxide, peroxide, or superoxide, or alkaline earth metal oxide, peroxide, or superoxide core, and a catalytic nanoshell or skeleton surrounding the cores, as well as methods of manufacture, are described. Additionally, sealed electrochemical devices including a solid oxygen-redox nanocomposite are also described.

### CROSS-REFERENCE TO RELATED APPLICATIONS

This application claim the benefit of priority under 35 U.S.C. § 119(e) of U.S. provisional application No. 62/266,783, filed Dec. 14, 2015, and U.S. provisional application No. 62/360,909, filed Jul. 11, 2016, the disclosures of which are incorporated by reference in their entirety.

### FIELD

Disclosed embodiments are related to redox electroactive materials.

### BACKGROUND

Investigations into novel cathodes for use in Li-ion batteries have been conducted in an effort to provide lower cost and higher energy density alternatives to transition metal oxide electrodes. In one specific example, the Li-air battery uses oxygen gas→lithium oxide as a cathode and has a high theoretical capacity. However, Li-air batteries have been difficult to implement, and have not been widely adopted, because they exhibit extremely high over potential loss (>1.2V) and low efficiencies due to a solid to gas phase change during cycling. Additionally, Li-air batteries require high cost components such as an electrolyte stable in the presence of both O₂ (gas) and lithium oxides as well as a semipermeable membrane that prevents CO₂ and H₂O in the air from contacting the cathode during cycling. These limitations prevent most Li-air battery systems from cycling at commercially acceptable rates of charge and numbers of cycles.

### SUMMARY

In one embodiment, an electroactive nanocomposite material includes: an electroactive core comprising at least one of an alkali metal oxide, peroxide, or superoxide, or an alkaline earth metal oxide, peroxide, or superoxide; and a nanoshell or skeleton surrounding the core.

In another embodiment, a method of preparing an electroactive nanocomposite material includes: placing core particles in a solvent, where the core particles comprise at least one of an alkali metal oxide, peroxide, or superoxide, or an alkaline earth metal oxide, peroxide, or superoxide; placing a transition metal salt in the solvent; and precipitating a nanoshell or skeleton comprising a transition metal onto the particles to form a nanocomposite.

In yet another embodiment, a sealed electrochemical device includes a cathode, an anode, and an electrolyte, wherein the cathode comprises an electroactive nanocomposite material that includes: an electroactive core comprising at least one of an alkali metal oxide, peroxide, or superoxide, or an alkaline earth metal oxide, peroxide, or superoxide; and a nanoshell or skeleton surrounding the core.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 depicts a schematic structure of an exemplary nano-lithia cathode including a Co₃O₄ skeleton surrounding amorphous Li₂O/Li₂O₂/LiO₂ cores.

FIG. 2 depicts a scheme for an exemplary method of preparing solid oxygen-redox nanocomposite materials for fully sealed batteries.

FIG. 3 shows a TEM of a Li₂O and Co₃O₄ nanocomposite material. The inset is the selected area electron diffraction (SAED) pattern of the material.

FIG. 4 shows charge/discharge curves of a Li₂O and Co₃O₄ solid oxygen-redox nanocomposite material with 67 wt % of Li₂O (NC-67) cathode in a coin-cell battery with lithium metal anode. The cell was charged to 615 Ah/kg, and then discharged to 2.0 V with a constant current of 120 A/kg. Different cycles (1st-150th) are indicated.

FIG. 5 shows the cycling performance of an NC-67 cathode in a coin-cell battery with the charge/discharge capacity and coulombic efficiency plotted against a lithium metal anode.

FIG. 6 shows the charging curves (solid curves, left axis) and in situ differential electrochemical mass spectrometry (DEMS) (dotted curves, right axis) for gas detection at different current densities for an NC-67 cathode.

FIG. 7 shows a cyclic voltammogram of an NC-67 cathode between 2.35 and 3.0 V with a scan rate of 0.05 mV/s. The horizontal arrow indicates the scanning direction. The ΔU between the oxidation and reduction peaks is 0.24 V.

FIG. 8 shows X-ray photoelectron spectra (XPS) after the first charge and discharge for an exemplary Li₂O/Co₃O₄ cathode, indicating an unchanged valence for cobalt.

FIG. 9 shows in situ Raman spectra at different charge and discharge states for an exemplary Li₂O/Co₃O₄ cathode. The peaks in highlighted regions are consistent with the presence of Li₂O₂ and LiO₂.

FIG. 10 shows in situ X-ray diffraction (on electrode foil) at different charge/discharge states for an exemplary Li₂O/Co₃O₄ cathode. The peaks in the highlighted regions are consistent with the presence of Li₂O.

FIG. 11 shows the in situ selected area electron diffraction (SAED) pattern of a Li₂O/Co₃O₄ cathode charged to 2.95 V. The corresponding curve was obtained by Digital Micrograph (Gatan) from the SAED pattern in the inset.

FIG. 12 shows ⁶Li nuclear magnetic resonance (NMR) spectra of standard Li₂O and Li₂O₂ crystals and an NC-67 material at different charge and discharge states after dimethoxyethane (DME) washing. All spectra are referenced to 1 M LiCl solution at room temperature.

FIG. 13 shows electron spin resonance (ESR) spectra at 70 K for an NC-67 cathode before and after charging to 600 mAh/g.

FIG. 14 shows the voltage profile of an NC-67 cathode charged to about 9,000 Ah/k. The voltage profile exhibits a voltage plateau corresponding to a phenomenon that may be used for battery overcharge protection through a shuttling reaction within the carbonate electrolyte during charging.

FIG. 15 depicts reactions for one embodiment of a proposed shuttle process at the end of charge. For ethylene carbonate (EC) in electrolyte, the solvated O₂⁻ reacts with EC, forming an intermediate peroxide radical A, then A diffuses to the anode and acquires electrons to become A^{x-}; the A/A^{x-} redox couple provides the shunting current through the liquid electrolyte.

FIG. 16 depicts a proposed mechanism for the formation of a peroxide radical from EC and O₂⁻, and depicts the electrochemical reaction of the proposed redox couple A/A^{x-}.

FIG. 17 shows cyclic voltammograms of electrolyte extracted before and after charging of a cell with an NC-67 cathode, at scanning rates from 10 mV/s to 100 mV/s between 2.4 V and −3.1 V in a Pt/Li/Li three-electrode system.

FIG. 18 shows the in situ electron spin resonance (ESR) of the electrolyte before and after charging at room temperature, indicating the formation of an ESR-active shuttling species in the charged electrolyte.

FIG. 19 shows charge and discharge curves for an NC-67 cathode in a lithium-matched full-cell battery against a Li₄Ti₅O₁₂ anode. A coin cell was charged to 600 Ah/kg with a current of 120 A/kg based on Li₂O, then discharged to 0.5 V. This cell was fabricated with a capacity ratio of 100:110 for NC-67 versus Li₄Ti₅O₁₂.

FIG. 20 shows the cycling performance of an NC-67 cathode in lithium-matched full-cell batteries against a Li₄Ti₅O₁₂ anode. A coin cell was charged to 600 Ah/kg with a current of 120 A/kg based on Li₂O, then discharged to 0.5 V. This cell was fabricated with a capacity ratio of 100:110 for NC-67 versus Li₄Ti₅O₁₂.

FIG. 21 shows charge and discharge curves for cathodes with different Li₂O amounts (NC-78: 78% w/w Li₂O, NC-67: 67% w/w Li₂O, and NC-53: 53% w/w Li₂O) at a constant current of 100 A/kg. The discharge capacities and currents are based on the total combined weight of Li₂O and CO₃O₄.

FIG. 22 shows the discharge capacity over 50 cycles with different Li₂O percentages (NC-78: 78% w/w Li₂O, NC-67: 67% w/w Li₂O, and NC-53: 53% w/w Li₂O) and at the indicated current densities. The discharge capacities and currents are based on the total weight of Li₂O and Co₃O₄.

FIG. 23 shows a Transmission Electron Micrograph and points sampled with Energy Dispersive X-ray Spectroscopy (EDS) for an NC-67 material to determine the ratio of Co:O at the marked locations in the image.

FIG. 24 shows a section of the charging curves at 120 A/kg from FIG. 4 between 2.7 V and 3.1 V.

FIG. 25 shows the discharge curves of an NC-67 cathode after 15 days of overcharging, after being stored for 2 to 10 days, and after recovered charging to a nominal 100% state of charge capacity (610 mAh/g).

FIG. 26 shows the differential electrochemical mass spectrometry (DEMS) for an NC-67 cathode with constant current in a charge and discharge process, with mass detection at m/z=32 for O₂ and m/z=44 for CO₂.

FIG. 27 shows the differential electrochemical mass spectrometry (DEMS) for an NC-67 cathode during cyclic voltammetry, the first two segments are tested between 2.2V and 3.0 V, and the third cycle goes to 3.5 V. Mass detection was at m/z=32 for O₂ and m/z=44 for CO₂.

FIG. 28 shows the Raman spectra of an NC-67 cathode at different states of charge and discharge after thorough washing of the cathode with dimethoxyethane (DME).

FIG. 29 displays SAED patterns of an NC-67 cathode at different states of charge and after 10 cycles. In the original before initial charging of the cathode, there were some bright diffraction points within a diffraction ring due to well-crystalized Li₂O (111), but the bright diffraction points disappeared and gradually became a sharp diffraction ring during charging, becoming more uniform but broader and darker after 10 cycles.

FIG. 30 depicts chemical shifts for Li₂O, LiOH, Li₂O₂, and LiO₂ calculated using density functional theory (DFT) in comparison with NMR spectrum reported in the literature.

FIG. 31 is a graph of the current peak iₚ and square root of scanning rate ν^{1/2} in the CV measurement of electrolyte from a cell with an NC-67 cathode. The corresponding CVs are depicted in FIG. 17.

### DETAILED DESCRIPTION

Without wishing to be bound by theory, the inventors have recognized that development of lower-cost, higher-efficiency batteries, for example rechargeable Li-ion batteries, has been limited due to gravimetric capacity limitations of electroactive cathode materials based on the redox of transition metal cations (e.g., Co, Mn, Ni, Fe). Anion-redox batteries, such as Li-air or Li-sulfur batteries, may offer a potentially higher capacity alternative to cation-redox batteries, but have limitations of their own. First, Li-air batteries have a high voltage gap between charge and discharge due to high over potentials resulting in part from the gas evolution and gas-to-condensed-phase changes that typically occur at Li-air cathodes. The total over potential loss is greater than 1.2 V (η_{charging}>1.1 V, η_{discharging}>0.1 V), creating a large energy inefficiency and thermal management issues. Second, the large volume hysteresis associated with repeated phase changes between condensed and gaseous phases may limit the cyclability of Li-air batteries. Additionally, the gas breathing aspect restricts the use of Li-air batteries in fully sealed conventional battery cells. Auxiliary components like O₂-selective membranes and pumps also contribute to such systems having a high cost and large footprint. It is currently impossible, for example, to make Li-air battery with the size of a R2032 coin cell. The current disclosure is directed to battery chemistries and methods that in some embodiments demonstrate may address one or more of the above noted problems. Though embodiments, in which different benefits are realized using the disclosed materials are also possible.

In view of the above, the inventors have recognized that it may be desirable to develop an oxygen anion redox electroactive material that does not release and/or consume oxygen gas (O₂) during normal usage between upper and lower operating voltages. Therefore, such an electroactive material may undergo one or more phase changes between only condensed-matter phases during charging and discharging processes. For example, in one embodiment, the Inventors have recognized the benefits associated with using an electroactive material including a solid oxidant that transitions between one or more solid phases during a charge discharge cycle.

In a metal-air battery the oxygen atoms cycle between an oxygen valence state of Z=0 for O₂ gas and Z=−2 for O²⁻ (e.g., in solid Li₂O). Therefore, to avoid the gaseous phase completely, in some embodiments, the valence state of oxygen should be kept within the range −2≤Z<0. For example, in one embodiment, the oxygen atoms within an electroactive material may be cycled between Z=−2 for O²⁻ (oxide) and Z=−1 for O₂²⁻ (peroxide), between Z=−2 for O²⁻ (oxide) and Z=−0.5 for O₂⁻ (superoxide), and/or between Z=−1 for O₂²⁻ (peroxide) and Z=−0.5 O₂⁻ (superoxide). As described further below, this may either be controlled by controlling the voltages a material is cycled between and/or an electrolyte may be included in an electrochemical cell to inherently limit the voltage potentials the electroactive materials may be exposed to during operation.

Based on the foregoing, in one embodiment, an electroactive material may include a solid light-anion (e.g., O, Cl, S, B, C, N, F, P) containing core. In certain embodiments, the solid oxidant core comprises at least one of an alkali metal oxide, peroxide, superoxide, or combination thereof. Alternatively, the core may include an alkaline earth metal oxide, peroxide, superoxide, or combination thereof. The alkali metals include, but are not limited to, lithium (Li), sodium (Na), and potassium (K). The alkaline earth metals include, but are not limited to beryllium (Be), magnesium (Mg), calcium (Ca), strontium (Sr), and barium (Ba).

As noted above, possible electroactive core compositions include any alkali metal oxide, peroxide, or superoxide, or alkaline earth metal oxide, peroxide, or superoxide as a solid oxidant. In some embodiments, the core comprises an alkali metal oxide, peroxide, or superoxide, or a mixture thereof. For example, in one particular embodiment, a solid oxidant core comprises lithium oxide, lithium peroxide, lithium superoxide, or a combination thereof. In another embodiment, the core may comprise sodium oxide, sodium peroxide, sodium superoxide, or a mixture thereof. In some embodiments, the core comprises potassium oxide, potassium peroxide, potassium superoxide, or a mixture thereof. In yet another embodiment, the core comprises an alkaline earth metal oxide, peroxide, or superoxide, or a mixture thereof. In some embodiments, the core comprises magnesium oxide, magnesium peroxide, magnesium superoxide, or a mixture thereof. In some embodiments, the core comprises calcium oxide, calcium peroxide, calcium superoxide, or a mixture thereof. Combinations of the above noted compositions are contemplated, for example, a core may comprise both lithium oxide and sodium oxide.

Without wishing to be bound by theory, a solid oxidant, such as an alkali or alkaline earth metal oxide may undergo structural changes during charging or discharging of the electroactive material. For example, upon charge, an oxide may be oxidized to form a peroxide or superoxide, and upon discharge a peroxide or superoxide may be reduced to form an oxide. These changes in the average oxygen valence state (Z) and corresponding changes in coordination of oxygen with alkali and alkaline earth cations may change the structural dimensions and crystalline or amorphous states of the solid oxidant. Z should be maintained below 0 (when Z equals zero, O₂ gas will evolve). In other words, to cycle within Z=−2 (oxide), Z=−1 (peroxide), Z=−0.5 (superoxide) and mixtures of these states.

To help avoid degradation of a solid oxidant electroactive core material during the above noted transitions, in one embodiment, one or more solid oxidant cores may be surrounded by a shell or skeleton. The resulting nanocomposite structure including a core or cores surrounded by a shell or skeleton is typically referred to as a cores-and-skeleton structure. While any size thickness shell/skeleton may be used, in some embodiments, the shell/skeleton has characteristic thickness and pore size both below 100 nm as elaborated on further below. However, it should be understood that the described embodiments may include any appropriate thickness skeleton capable of providing the desired structural and/or electrochemical properties.

Any appropriate material may be used for the skeleton that is capable of conducting one or more desired alkali or alkaline earth cations, and electrons. The skeleton material may be selected such that the material is stable at the electrochemical potentials contemplated for use of the electroactive material. Thus, in some embodiments, the skeleton material will not be oxidized or reduced in the cathode potential range. In some embodiments, the skeleton may comprise a metal oxide or metal. In one such embodiment, the skeleton may comprise a transition metal oxide. For example, the shell or skeleton may comprise one or more of, cobalt oxides (e.g., Co₃O₄), nickel oxides, manganese oxides, iron oxides, copper oxides, and solid mixtures of these compounds or mixed metal oxides (e.g., NiCo₂O₄), or any other suitable material. In another embodiment, the shell or skeleton may comprise a heavy metal. For example, the shell or skeleton may comprise one or more of, nickel, gold, silver, and platinum, or other suitable metals and alloys. Additionally, combinations of the above materials are contemplated, for example a shell or skeleton may comprise both cobalt oxide and manganese oxide.

The shell or skeleton may be directly bonded to the electroactive core material and/or separated by an interfacial wetting layer. In some embodiments, the solid oxygen-redox nanocomposite material comprises void pore spaces inside to allow liquid electrolyte percolation that may form a solid-electrolyte interphase (SEI) layer between the solid oxidant material and the skeleton. The skeleton and/or SEI layer may act as a catalyst for redox of the electroactive material. In some embodiments, the nanocomposite has a lower over potential for charge and/or discharge of the electroactive core material than the electroactive core material without a shell or skeleton.

Without wishing to be bound by theory, a light-anion (e.g., O, Cl, S, B, C, N, F, P) containing electroactive core “solid oxidant” material may undergo extraction/insertion of cations during charging or discharging. For example, a lithium oxide core may upon charge extract Li⁺ ions from the core to form lithium peroxide and/or lithium superoxide. And upon discharge the core may, for example, correspondingly insert Li⁺ ions into the core to reform lithium oxide. The intercalation and the transition between different oxidation states of the solid oxidant may result in a volume change of the core. Similarly, without wishing to be bound to theory, the intercalation and transition between different oxidation states may change the solid state form of the core material. In some embodiments, a core material may initially be present in a first crystalline or amorphous form, but following cycling, and/or when in a different state of charge, the core material may have a second crystalline or amorphous form.

In addition to the above, in some embodiments, a shell or skeleton may be permeable to at least one of an alkali or alkaline earth metal ion of a material present in a corresponding solid oxidant core (e.g., a Li⁺ permeable shell for a Li₂O core). Thus, during charge and discharge of the electroactive material, the electroactive ions are able to pass through the shell or skeleton permitting insertion and extraction of the ions to and from the solid oxidant core.

Depending on the embodiment, a shell or skeleton may be permeable to one or more organic electrolytes such as those described further below. However, in other embodiments, the shell or skeleton may be impermeable to the one or more organic electrolytes as the disclosure is not so limited. Permeability of a shell or skeleton may be due to inherent permeability of the shell or skeleton material, or alternatively due to defects in the shell or skeleton or incomplete encapsulation of a core material.

Depending on the method of manufacture and/or a state of charge of an electroactive material including cores surrounding by a shell/skeleton, the shell/skeleton may or may not include a void space therein. For example, in one embodiment, an electroactive material may include yolk and shell particles with, one or more shells disposed on the surfaces of one or more corresponding cores. However, in another embodiment, there may be a void space located between the surface of one or more cores and the internal surfaces of one or more corresponding shells. Further, it should be understood that this void space may correspond to any desirable percentage of the internal volume of a shell as the disclosure is not so limited.

While the above embodiments have described a shell surrounding a single core, in some embodiments, a yolk and shell particle may contain multiple cores contained within a single shell. For example, a plurality of cores, may be disposed within a shell or skeleton that surrounds the plurality of cores. As noted above, the shell or skeleton may fully enclose the plurality of cores such that the shell or skeleton excludes liquid electrolyte and/or gas molecules from the shell or skeleton interior. Further, it should be understood that a shell or skeleton may have any appropriate shape such that it encloses the multiple cores contained therein including both spherical shapes and/or non-spherical shapes as the disclosure is not limited in this fashion.

Without wishing to be bound by theory, the size of a core surrounded by shell or skeleton may affect its electrochemical properties and/or density. For example, larger particles may provide increased density for the electroactive material. However, some core materials, may be inactive above a certain particle sizes. In one such embodiment, and without wishing to be bound by theory, a solid oxidant core may include lithium oxide which may be inactive to be charged to lithium superoxide at particle sizes greater than about 20 nm, as the core may be too far away from the catalytic shell or skeleton interface. Thus, in some embodiments, the prevailing size of a core may be less than or equal to a maximum size to be able to be thermodynamically stabilized as well as kinetically catalyzed to be one or more phases of the core during a charge discharge cycle. Therefore, when choosing a particular core size, it may be desirable to select a core size that balances the need for high battery capacity (e.g., Ah/kg of electroactive material) with the need for high density of the solid phases of the solid oxidant. Of course, embodiments, in which different considerations influence a selected core size for an electroactive material are also contemplated as the disclosure is not so limited.

In view of the above, a size of cores that are both spherical and non-spherical may be described by a maximum dimension. For a spherical core the maximum dimension is the diameter. For non-spherical cores the maximum dimension is the maximum cross sectional distance between two points on opposing sides of the core. For example, a core may have a maximum dimension that is greater than about 1 nm, 2 nm, 5 nm, 10 nm, 20 nm, 30 nm, 50 nm, or any other appropriate length. Correspondingly, a core may have a maximum dimension that is less than about 100 nm, 50 nm, 30 nm, 20 nm, 10 nm, 5 nm or any other appropriate length. Combinations of the above are contemplated, including a core with a maximum dimension between about 1 nm and 100 nm, 2 nm and 20 nm, or 5 nm and 10 nm. However, other combinations and maximum dimensions both greater and less than those noted above are also possible.

Depending on the desired electrochemical properties, a shell or skeleton may have a number of different thicknesses. With wishing to be bound by theory, a thickness of a shell or skeleton may affect its mechanical strength and ionic conductance. For example, a very thick shell may have ionic conductance that is too low for efficient insertion/extraction of alkali or alkaline earth cations into or out of the core, and also reduce the weight proportion of the active material cores. However, a very thin shell may not have sufficient mechanical strength to undergo the expected size hysteresis of the electroactive core materials contained therein. Thus, it may be desirable to select a shell thickness that balances ionic transport properties with strength and impermeability relative to one or more elements or compounds. For example, a shell may have an average thickness that is greater than about 0.5 nm, 1 nm, 2 nm, 3 nm, 5 nm, or any other appropriate length. Correspondingly, a shell may have an average thickness that is less than about 10 nm, 5 nm, 3 nm, or 2 nm, or any other appropriate length. Combinations of the above are contemplated, including a shell with an average thickness between about 1 nm and 5 nm, or 2 nm and 3 nm, though other combinations and average thicknesses both greater and less than those noted above are also possible.

In some instances, a particular crystal structure of a shell and/or core may be desirable for either strength and/or conductive properties. Therefore, it should be understood that any appropriate crystalline form may be used for either the shell or core. In some embodiments, the core and/or shell may be calcined and/or annealed to provide a desired crystalline form.

As noted above the size of the core and thickness of the shell may affect various electrochemical and mechanical properties of the electroactive material. Additionally, particular ranges of relative quantities of the core material and shell material may be desirable. Greater relative amounts of core material may increase the charge capacity, but too low a percent of shell material may make the shell too thin or permeable, or too prone to defect or rupture. Therefore, the relative amounts of core material and shell material may be selected to balance these competing factors. The relative amounts may be measured in any appropriate manner, for example, by weight percent of the total electroactive material or by molar ratios. In some embodiments, the weight percent of core material in the electroactive material is greater than about 50%, 60%, 70%, 80%, 90%, or any other appropriate weight percent. Correspondingly, in some embodiments, the weight percent of core material in the electroactive material is less than about 90%, 80%, 70%, 60%, 50%, or any other appropriate weight percent. Combinations of the above are contemplated, including embodiments with a weight percent of core material in the electroactive material between about 50% and 90%, 60% and 80%, 50% and 60%, 60% and 70%, 70% and 80%, and 80% and 90%, though other combinations and weight percentages both greater and less than those noted above are contemplated.

The charge capacity of the solid oxygen-redox nanocomposite material will depend on the percent weight of the solid oxidant versus the total weight. However, according to some embodiments, a charge capacity of an electroactive material may be greater than about 200 Ah/kg, 300 Ah/kg, 400 Ah/kg, 500 Ah/kg, 600 Ah/kg, 700 Ah/kg, 800 Ah/kg, 900 Ah/kg, 1000 Ah/kg, or any other appropriate charge capacity. Correspondingly, the charge capacity of the electroactive material may be less than about 1000 Ah/kg, 900 Ah/kg, 800 Ah/kg, 700 Ah/kg, 600 Ah/kg, 500 Ah/kg, or any other appropriate charge capacity. Combinations of the above are contemplated, including electroactive materials with a charge capacity between about 500 Ah/kg and 1000 Ah/kg, between 600 Ah/kg and 900 Ah/kg, and between 300 Ah/kg and 500 Ah/kg, though other combinations and charge capacities both less than and greater than those noted above are also possible.

A solid oxygen-redox nanocomposite material as discussed herein may be used in any number of electrochemical devices. These include, but are not limited to use in both primary, secondary batteries, pseudocapacitors, super capacitors, fuel cells, photoelectrochemical cells, to name a few. While the disclosed materials may be of use in any number of different electrochemical systems, these materials may be of particular use in alkali or alkaline earth cation based or similar electrochemical devices (e.g., Li-ion batteries). In some embodiments, an electroactive material including a plurality of nanocomposite particles may be used in an electrochemical device. For example, the nanocomposite particles may function as an electroactive material on at least one of first and second opposing electrodes in an electrochemical device, including in one specific embodiment, the electroactive material present on a cathode of an electrochemical device. In such an embodiment, the electroactive material is electrically coupled to an associated current collector. In order to appropriately couple the electroactive material to the associated current collectors as well as providing ionic conduction between the two opposing electrodes, one or more conductive agents and/or binders may be used in conjunction with the presently disclosed materials to form the electrodes. While a particular type of electrochemical structure is described herein, it should be understood that the presently disclosed materials are not limited to only this application as the disclosure is not so limited. Without wishing to be bound by theory, the encapsulation of the solid oxidant with a shell or skeleton or partial coverage by a shell or skeleton may provide improved stability of the electroactive material towards repeated electrochemical cycling. Thus, the electroactive material may be useful as a component of a cathode in a secondary battery (e.g., a rechargeable battery), though applications in primary batteries (e.g., non-rechargeable batteries) are also contemplated.

The electroactive materials discussed herein may be used in any type of sealed (non air breathing) primary or secondary battery or other electrochemical device. In some embodiments, the electrochemical device comprises a coin cell or button cell. In some embodiments, the electrochemical device comprises a prismatic cell, cylindrical cell, or pouch cell within which one or more electrodes including the disclosed electroactive materials are disposed. While any number of configurations may be used, in one embodiment, a sealed electrochemical device may be made by placing the components (e.g., cathode, anode, electrolyte, etc.) in a container and sealing the container in any appropriate fashion. Exemplary sealed containers may be made using metal, metallic foil, rigid plastic, flexible plastic, glass, ceramic, combinations of the above, or any other suitable material as the disclosure is not so limited. Metal containers may, for example, be made out of stainless steel, titanium or titanium alloys, or aluminum or aluminum alloys, or any other suitable metal or metal alloy depending on the chemistries and voltages used during operation as the disclosure is not so limited. Containers comprising combinations of housing materials are also contemplated. For example, a container may be made out of rigid plastic, flexible plastic, glass, or ceramic with a coating of one or more layers of metal or metallic foil, though other combinations of housing materials are also contemplated.

While the electroactive materials are described as being used in a fully sealed electrochemical device above, it should be understood that the electroactive materials discussed herein may be also be used in an unsealed battery system, such as an air battery, as well because the disclosure is not so limited.

In one embodiment, an electroactive material is used in an electrochemical device such as a battery comprising a cathode, and anode, and an electrolyte. The anode may be any appropriate anode, for example, an anode that can insert/extract an alkali metal or alkaline earth metal (e.g., a Li-ion and/or Li metal anode). In some embodiments, for example, an anode may include one or more of a lithium titanate, graphite, hard carbon, tin, cobalt, tin/cobalt alloy, aluminum, silicon, lithium metal, a combination thereof, or any other appropriate electroactive material appropriate for use as an anode of an electrochemical cell as the disclosure is not so limited.

An electrolyte used in an electrochemical cell incorporating the electroactive materials discussed herein may include any appropriate electrolyte compatible with the materials. For example, in one embodiment, an electrolyte may comprise an organic solvent and an electrolyte salt. In one such embodiment, the electrolyte comprises a carbonate or a mixture of carbonates. In some embodiments, the electrolyte comprises ethylene carbonate, propylene carbonate, dimethyl carbonate, diethylcarbonate, ethyl methyl carbonate, vinylene carbonate or fluoroethylene carbonate, or a mixture thereof. In some embodiments, the electrolyte comprises dimethylsulfone, dimethoxyethane, or a mixture thereof. In some embodiments, the electrolyte comprises ethylene carbonate and diethylcarbonate (e.g., in a ratio between about 1:5 and about 5:1, in a ratio of about 1:1). The electrolyte may also comprise an electrolyte salt as noted above. In some embodiments, the electrolyte salt may comprise a salt with a cation that is the same as that cation of the solid oxidant core material (e.g., a lithium salt and a Li₂O core). In some embodiments, the electrolyte salt comprises a lithium salt (e.g., LiTFSI, LiClO₄, LiBr, LiI, LiPF₆). Though embodiments in which a salt comprises a sodium, potassium, rubidium, cesium, beryllium, magnesium, calcium, strontium, or barium salt are also contemplated as the disclosure is not so limited. In some embodiments, the electrolyte comprises a liquid electrolyte, solid electrolyte, slurry electrolyte, or polymer gel electrolyte.

A battery may optionally include a separator to insulate electrical contact between an anode and cathode. The separator may be any appropriate material including, for example, a polymer membrane, glass, ceramic, or zeolite. In some embodiments, the separator is a porous separator. In some embodiments, the separator is a non-porous separator permeable to ions. In some embodiments, the separator is permeable to cations (e.g., Li⁺, Na⁺, K⁺, Mg²⁺, Ca²⁺). In some embodiments, the separator is permeable to anions.

According to some embodiments, the battery may have a discharge capacity, based on cathode mass, greater than about 200 Ah/kg, 300 Ah/kg, 400 Ah/kg, 500 Ah/kg, 600 Ah/kg, 700 Ah/kg, 800 Ah/kg, 900 Ah/kg, 1000 Ah/kg, or any other appropriate discharge capacity. Correspondingly, the battery may have a discharge capacity, based on cathode mass, less than about 1000 Ah/kg, 900 Ah/kg, 800 Ah/kg, 700 Ah/kg, 600 Ah/kg, 500 Ah/kg, or any other appropriate charge capacity. Combinations of the above are contemplated, including batteries with discharge capacities, based on cathode mass, between about 500 Ah/kg and 1000 Ah/kg, 600 Ah/kg and 900 Ah/kg, and 300 Ah/kg and 500 Ah/kg, though other combinations and charge capacities both less than and greater than those noted above are also possible.

According to some embodiments, the battery may have an energy density, based on cathode mass, greater than about 400 Wh/kg, 600 Wh/kg, 800 Wh/kg, 1000 Wh/kg, 1200 Wh/kg, 1400 Wh/kg, 2000 Wh/kg, or any other appropriate energy density. Correspondingly, the battery may have an energy density, based on cathode mass, less than about 3400 Wh/kg, 2700 Wh/kg, 2400 Wh/kg, 2100 Wh/kg, 1800 Wh/kg, 1500 Wh/kg, or any other appropriate energy density. Combinations of the above are contemplated, including energy densities, based on cathode mass, between about 400 Wh/kg and 1200 Wh/kg, 1200 Wh/kg and 1600 Wh/kg, 1600 Wh/kg and 2400 Wh/kg, and 2400 Wh/kg and 3400 Wh/kg, though other combinations and energy densities both less than and greater than those noted above are also possible.

In some embodiments, an electrochemical device including the electroactive materials discussed herein is capable of operating with high current efficiency. The term “current efficiency” or “coulombic efficiency” refers to the ratio of total charge drawn during a period of discharge to the total charge passed during a corresponding period of charge. The current efficiency can be determined by counting the amp-hours passed while charging the battery between two cutoff voltages (e.g., 0% to 100% state of charge), and counting the amp-hours passed while discharging the battery back to the original state (e.g., 100% to 0% state of charge), and dividing the amp-hours for the discharge step by the amp-hours for the charge step. For example, the current efficiency of a battery including the electroactive material discussed herein may be greater than about 70%, 75%, 80%, 85%, 90%, 95%, 97%, or any other appropriate current efficiency. Correspondingly the current efficiency may be less than about 100%, 97%, 95%, 90%, or any other appropriate current efficiency. Combinations of the above are contemplated, including current efficiencies between about 90% and about 95%, between about 95% and about 99%, and between about 99% and 100%, though other combinations and current efficiencies both less than and greater than those noted above are also possible.

In some embodiments, an electrochemical device including the electroactive materials discussed herein is capable of operating with high voltage efficiency. The term “voltage efficiency” refers to the ratio of the cell voltage at discharge to the voltage at charge. Voltage efficiency is determined for a given current, for example, by measuring the voltage at a given current while charging and dividing by the voltage at the same current while discharging. The voltage efficiency may be affected by a number of additional factors, including state of charge and over potential. For example, the voltage efficiency may be greater than about 70%, 75%, 80%, 85%, 90%, 95%, 97%, or any other appropriate voltage efficiency. Correspondingly the voltage efficiency may be less than about 100%, 97%, 95%, 90%, or any other appropriate voltage efficiency. Combinations of the above are contemplated, including voltage efficiencies between about 80% and about 90%, between about 90% and about 95%, and between about 95% and about 100%, though other combinations and voltage efficiencies both less than and greater than those noted above are also possible.

In some embodiments, an electrochemical device including the electroactive materials discussed herein is capable of operating with high energy efficiency. The term “energy efficiency” refers to the ratio of total electrical energy obtained from discharge to the electrical energy provided during charge in a cycle. The energy efficiency may be calculated as the product of the voltage efficiency and current efficiency. For example, the energy efficiency of the battery may be greater than about 60%, 70%, 75%, 80%, 85%, 90%, or any other appropriate energy efficiency. Correspondingly the energy efficiency may be less than about 100%, 95%, 90%, 85%, 80%, 75%, 70%, or any other appropriate energy efficiency. Combinations of the above are contemplated, including energy efficiencies between about 60% and about 100%, and between about 70% and about 90%, though other combinations and energy efficiencies both less than and greater than those noted above are also possible.

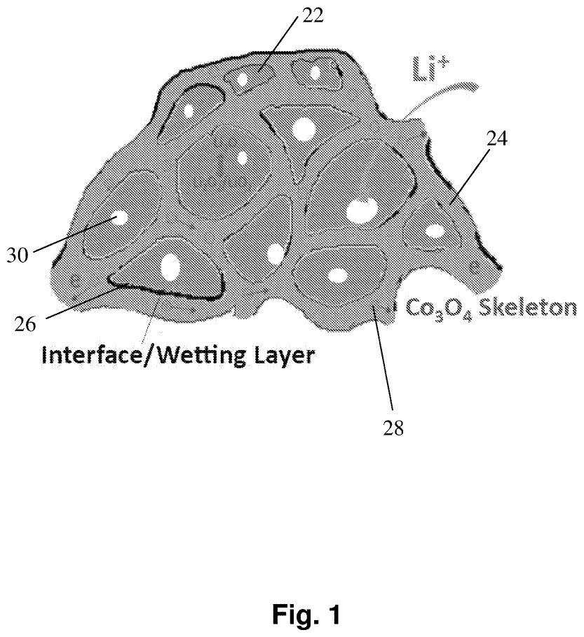

One embodiment of a solid oxygen-redox nanocomposite electroactive material as discussed herein is depicted in FIG. 1, but the disclosure is not limited to only the depicted material. In the depicted embodiment, the material comprises cores of solid oxidant material 22 comprising lithium oxide, lithium peroxide, and/or lithium superoxide, and a skeleton 24 comprising Co₃O₄. The composition of the solid oxidant cores may vary during a charge discharge cycle, for example, the cores may comprise primarily lithium oxide (Li₂O, Z=−2) before charge, and primarily lithium peroxide (Li₂O₂, Z=−1) or lithium superoxide (LiO₂, Z=−0.5) or amorphous mixtures thereof after charge. In the depicted embodiments, there is an interfacial wetting layer 26 between the cores and the skeleton. In some embodiments, the solid oxygen-redox nanocomposite material also comprises void pore spaces inside to allow liquid electrolyte percolation, bonds between the solid oxidant material and the skeleton in the interfacial wetting layer, or a solid-electrolyte interphase layer between the solid oxidant material and the skeleton and/or liquid electrolyte, or a combination thereof.

Application of a current to the electroactive material is depicted in FIG. 1. As depicted in the figure, the applied current may cause electrons and ions to move in or out of the solid oxidant material and/or skeleton. For example, a charging current may cause electrons 28 present in a Li₂O/Li₂O₂/LiO₂ solid oxidant material to move across the interfacial wetting layer, through the Co₃O₄ skeleton and conductive agents, and into a current collector. Correspondingly, the charging current may also cause lithium ions in the Li₂O/Li₂O₂/LiO₂ solid oxidant material to move through the Co₃O₄ skeleton into an electrolyte in contact with the skeleton, or directly into the electrolyte in the percolating pores. In a converse example for discharge, a discharge current may cause electrons from a current collector in electrical contact with the skeleton to move through the Co₃O₄ skeleton, across the interface layer, and into the Li₂O/Li₂O₂/LiO₂ solid oxidant material. Correspondingly, the discharge current may also cause lithium ions present in electrolyte to move into the Li₂O/Li₂O₂/LiO₂ solid oxidant material.

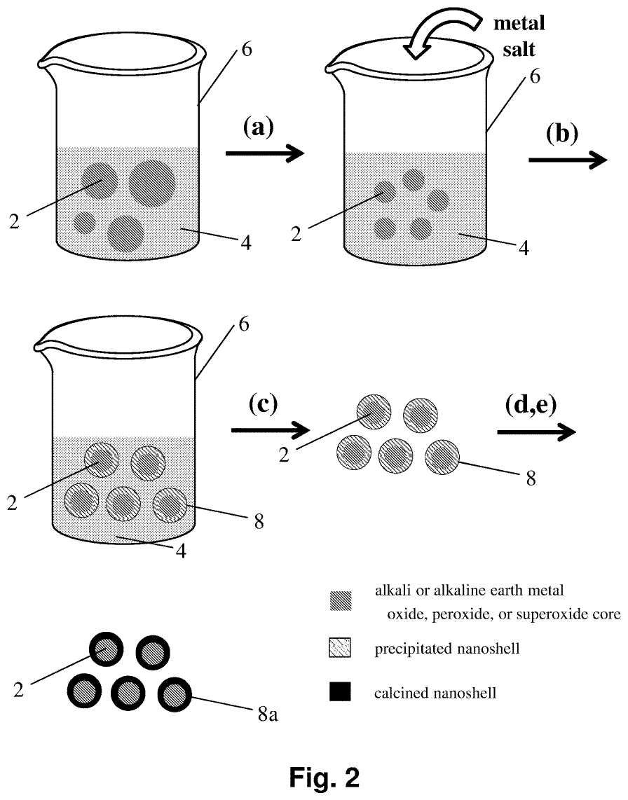

One embodiment of a method for preparing a nanocomposite electroactive material as discussed herein is depicted in FIG. 2, but the disclosure is not limited to only the depicted method. Instead, the current disclosure also contemplates methods involving more or fewer steps, methods with a different order of steps, and methods involving other processes known in the art. In the depicted embodiment, the method includes placing particles of a solid oxidant core material 2 in a solvent bath 4 of a reaction container 6 at step (a). A transition metal salt is then placed in the solvent followed by precipitating a nanoshell 8 comprising a transition metal onto the surfaces of the core particles, step (b). The particles, transition metal salt, and solvent may be combined in any order, that is, they may be added to the reaction container or process in any order. For example, the core particles, transition metal salt, and solvent may be added to the reaction container or process in any appropriate way including each at one time, simultaneously, in batches, or in any other appropriate manner. In some embodiments, the core solid oxidant material (e.g., an alkali metal oxide, peroxide, or superoxide, or an alkaline earth metal oxide, peroxide, or superoxide) is substantially insoluble in the solvent. However, embodiments, in which the core solid oxidant material is soluble, partially soluble in the solvent, and/or precipitated out of the solvent are also contemplated.

The precipitation of transition metal nanoshells or nanoskeletons onto the particles corresponding to one or more solid oxide cores within the solvent may occur upon combination of the core particles, transition metal salt, and solvent, or may occur when the mixture is exposed to suitable reaction conditions. Suitable reaction conditions may include a temperature range, pressure range, pH range, concentration range, stirring rate, and/or method of stirring. In certain embodiments, the precipitation reaction may include heating the reaction mixture, cooling the reaction mixture, or exposing the reaction mixture to one or more temperature changes. In certain embodiments, the precipitation reaction may include adding one or more additional chemicals. In some embodiments, the additional chemical may be a second solvent, an acid, a base, and/or a salt, or any other suitable chemicals. In certain embodiments, the precipitation reaction may include concentrating the reaction mixture or diluting the reaction mixture. Also contemplated are reaction conditions that combine one or more of the above noted methods such as changing the temperature, changing the pressure, adding or removing a chemical, and changing the concentration of the reaction mixture. Of course other methods of controlling the precipitation reaction are also contemplated as the disclosure is not so limited.

Depending on the embodiment, the solvent located within the bath 4 of FIG. 2 may be water, an organic solvent, a mixture of water and organic(s), and/or a mixture of organic solvents. Appropriate organic solvents include, but are not limited to: an alcohol such as methanol, ethanol, isopropanol, or butanol; acetone; a carbonate; a mixture of the forgoing, or any other appropriate solvent as the disclosure is not so limited.

The transition metal salt may be any appropriate transition metal salt. In some embodiments, the transition metal salt is soluble or at least partially soluble in the solvent. In other embodiments, the transition metal salt is insoluble in the solvent. Also contemplated are methods in which more than one transition metal salt is placed in the solvent in order to precipitate a nanoshell or nanoskeleton including more than one transition metal therein. In some embodiments, the transition metal salt comprises a cobalt salt (e.g., cobalt chloride). In some embodiments, the transition metal salt comprises a manganese salt, iron salt, copper salt, or nickel salt. In some embodiments, the transition metal salt comprises halide anions. In some embodiments, the transition metal salt comprises fluoride, chloride, bromide, or iodide anions. In some embodiments, the transition metal salt comprises nitrate, perchlorate, sulfate, bisulfate, carbonate, bicarbonate, phosphate, hydrogen phosphate, or dihydrogen phosphate anions. In some embodiments, the transition metal salt comprises oxide or hydroxide anions. In some embodiments, the transition metal salt comprises alkali metal, alkaline earth metal, or ammonium and zinc cations. Of course, a transition metal salt comprising combinations of any of the above anions and/or cations are also contemplated.

In some embodiments, it may be desirable to reduce a size of the core particles placed into a solvent bath as shown in FIG. 2. Specifically, in the depicted method of preparing core particles and shell, the core particle size is reduced during step (a). Without wishing to be bound by theory, the particles may be sonicated by bombarding the particles with high energy sonic waves while in solution. Without wishing to be bound by theory, these sonic waves impact the particles causing local cavitation of the surrounding solvent with sufficient concentrated energy such that the cavitation breaks the particles apart to form smaller particles, as depicted in FIG. 2, step (a). In some embodiments, the particles have a first average maximum particle dimension before sonication and a smaller second average maximum particle dimension after sonication. The sonication may involve any appropriate sonic frequency or ultrasonic frequency (e.g., greater than 20 kHz). The time duration, frequency, and power of the sonication may be selected to provide a desired second average maximum particle dimension for the particles.

As also shown in FIG. 2, a method may optionally include drying the particles after precipitation. As depicted in step (c). Drying may be accomplished by any process known in the art, for example, filtration, drying in air, drying under vacuum, drying in an oven, and/or drying with a desiccant.

Once appropriately dried, the powder may be optionally calcined to form a transition metal nanoshell or nanoskeleton 8a, as depicted in step (d). Without wishing to be bound by theory, the transition metal salt may precipitate a nanoshell nanoskeleton comprising the transition metal in any number of coordination environments. The precipitated transition metal atoms may be coordinated by, for example, a crystal lattice of the core material, oxygen atoms from the core material, counter ions from the transition metal salt, molecules of solvent, counter ions or molecules derived from solvent, molecules of water, hydroxide, and anions from an additional chemical (e.g., acid, base, or salt), or combinations thereof. Calcination may convert the nanoshell or nanoskeleton from the initial precipitated form to a nanoshell or nanoskeleton comprising a compound including a transition metal and oxygen such as a transition metal oxide. Additionally, the calcination process may also convert individual yolk and shell particles to secondary aggregated particles, forming a skeleton structure.

Calcination may be accomplished by heating the nanocomposite (e.g., after precipitation and drying (FIG. 2, steps (b) and (c)) in an atmosphere comprising O₂. Calcination may be performed at any appropriate temperature. For example, nanocomposite may be calcined at a temperature greater than about 100° C., 200° C., 300° C., 400° C., or 500° C., or any other appropriate temperature. Correspondingly, the nanocomposite may be calcined at a temperature less than about 500° C., 400° C., 300° C., or 200° C., or less than the melting temperature of a shell/skeleton or core material. Combinations of the above are contemplated, including calcination at temperatures between or equal to about 250° C. and 350° C., though other combinations and temperatures including temperatures greater and less than those noted above are also possible. Calcination may also be conducted using any appropriate pressure. For example, in some embodiments, a calcination pressure may be ambient pressure (e.g., about 1 atm), between 1.1 atm and 2 atm, between 2 atm and 5 atm, between 5 atm and 10 atm, between 10 atm and 50 atm, greater than 50 atm, or any other appropriate pressure, in some embodiments, a calcination pressure may be less than ambient pressure, between 0 atm and 1 atm. Additionally, in some embodiments, the atmosphere may include greater than 90% O₂, greater than 95% O₂, greater than 98% O₂, or any other appropriate concentration.

A method of preparing core and shell/skeleton particles may also optionally comprise annealing step, as depicted in FIG. 2, step (e). Annealing may be performed before or after calcination, or both, or the annealing process may be combined with calcination. Annealing may also comprise one or more heating cycles and one or more cooling cycles. Annealing may be performed at any appropriate temperature. For example, the nanocomposite may be annealed at a temperature greater than about 100° C., 200° C., 300° C., 400° C., or 500° C., or any other appropriate temperature. Correspondingly, the nanocomposite particles may be annealed at a temperature less than about 500° C., 400° C., 300° C., or 200° C., or less than the melting temperature of a shell/skeleton or core material. Combinations of the above are contemplated, including annealing at temperatures between or equal to about 100° C. and about 500° C., about 200° C. and about 400° C., or about 250° C. and about 350° C., though other combinations and temperatures are also possible.

Without wishing to be bound by theory, in some embodiments, the evolution of oxygen gas (O₂, Z=0) at a cathode discussed herein may be prevented by an electrolyte shuttling mechanism. For many alkali metal or alkaline earth metal oxides, peroxides, or superoxides, oxygen gas evolution will occur above some potential. High potentials may be reached in a device with such a cathode, for example, at high charging currents and at locally high states of charge when the majority of oxygen atoms have been oxidized to the highest oxidation state stable in the solid state (e.g., Z=−0.5 for superoxide). However, if the potential at the cathode is limited to a potential below the potential for oxidation to O₂ (gas), gas evolution may be avoided. In some instances, this potential limitation occurs because an electrolyte-soluble species shuttling mechanism carries the current between the anode and cathode inside the electrolyte. In some embodiments, the shuttling mechanism involves an electrolyte-soluble species redox couple.

During charging of a device an electrolyte shuttling mechanism may pin the electrode potential to a value below a critical voltage at which O₂ gas would evolve at the electrode (e.g., 3.3 V versus Li/Li⁺), effectively acting as a “shunt” that pins the electrode voltage to a sub-critical constant value, independent of the charge capacity of the electrode itself. The potential of the shuttling mechanism may also be above the potential for the highest voltage plateau of a cathode discussed herein, such that the shuttling mechanism only has current during overcharging or at high over potential (e.g., at high charging rates). For example, the potential of the shuttle may be less than about 3.2 V, 3.15 V, 3.1 V, 3.05 V, 3.0 V, or 2.95 V versus Li/Li⁺, or any other appropriate potential. Correspondingly the potential of the shuttle may be greater than about 2.8 V, 2.85 V, 2.9 V, 2.95 V, or 3.0 V versus Li/Li⁺, or any other appropriate potential. Combinations of the above are contemplated, including a potential between or equal to about 2.9 V and about 3.1 V, though other combinations and potentials are also possible.

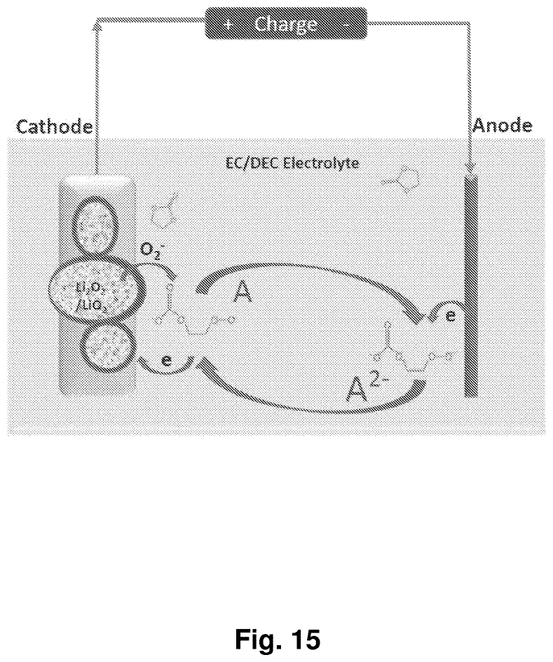

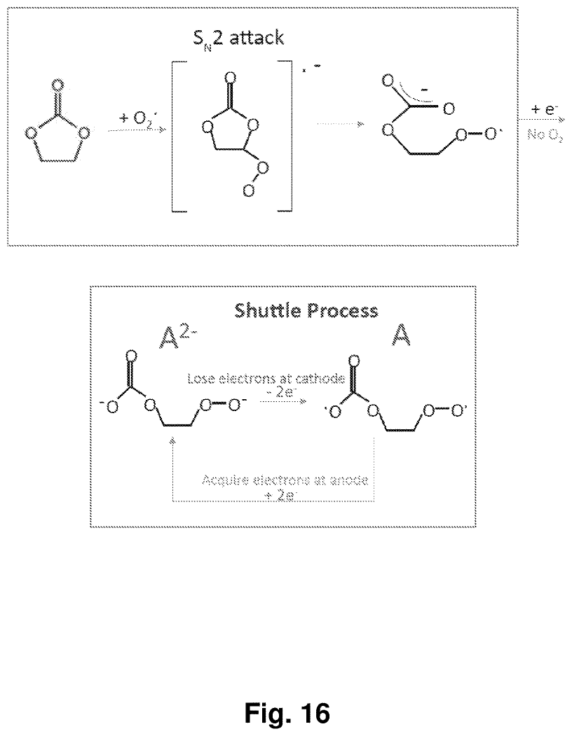

An exemplary shuttling mechanism is illustrated in FIG. 15 for a cathode with a Li₂O/Li₂O₂/LiO₂ solid oxidant core material, but the shuttling mechanism is contemplated for any cathode and core material discussed herein. In FIG. 15, the soluble redox couple, A/A^{x-} (x=1, 2, 3 . . . ) is formed when superoxide from the cathode reacts with carbonate electrolyte (e.g., ethylene carbonate). For example, the superoxide radical may attack carbonate in an S_{N}² attack as detailed in FIG. 16. This species can be oxidized at the cathode to radical A, then reduced at the anode to reform A^{x-}, and so on, to allow for the shuttling of current in a half-cell or full cell battery (FIGS. 15 and 16) which may automatically shunt the charging voltage of the electrode to a constant value below the oxygen evolution potential, no matter how long one charges or overcharges the electrode.

It should be understood that applicable shuttling mechanisms are not limited to only the example above. Other soluble species may facilitate electron shuttling between the anode and cathode. The shuttling may occur via another 2 electron redox couple similar to A/A²⁻, or may proceed via a one-electron couple or more than two electron couple (e.g., A/A⁻, A⁻/A²⁻; or A^{m-}/Aⁿ⁻, wherein m=1, 2, 3 . . . , n=1, 2, 3 . . . , provided m is different from n). The shuttling mechanism may also pass current via a combination of different redox couples. In some embodiments, the redox couple comprises species derived from solvent. In some embodiments, the redox couple comprises species derived from a carbonate solvent. In some embodiments, the redox couple comprises species derived from ethylene carbonate. In some embodiments, the redox couple comprises species derived from ethylene carbonate, propylene carbonate, dimethyl carbonate, diethyl carbonate, ethyl methyl carbonate, vinylene carbonate or fluoroethylene carbonate.

In addition to using a carbonate based electrolyte as a shuttling mechanism, other materials may also be used as, or with an, electrolyte to mediate redox to limit an electrochemical cell's voltage level during charging. For example, in one embodiment, one or more artificial shuttling redox mediator molecules (SRMs) may be present within a carbonate electrolyte, or other appropriate electrolyte. These SRMs may be designed to have a shuttling voltage that limits a cells charging voltage threshold to a voltage less than or equal to 3.4 V, 3.3 V, 3.2 V, 3.1 V, 3.0 V, 2.9 V, 2.8 V or any other appropriate voltage both greater and less than those noted above versus lithium metal. An SRM may have a well controlled oxidiation voltage such that each individual molecule may loses m electrons at a cathode where it is oxidized to become SRM^{m+}. SRM^{m+} molecules may be soluble in the electrolyte such that they diffuse to a corresponding anode of the electrochemical cell. Once at the anode the SRM^{m+} molecules may obtain electrons such that they are reduced back to SRM molecules. These SRM molecules may then diffuse back to the cathode where the process may be repeated. Thus, the inclusion of SRMs in the electrolyte of an electrochemical cell may use an oxidation process conducted at the cathode to limit the voltage during charging of the electrochemical cell for extended times, including after the electrochemical cell has reached a full state of charge, thus preventing overcharging of the electrochemical cell.

When designing an electrochemical cell to include a SRM to limit and/or substantially prevent overcharging of an electrochemical cell, three different design considerations may be taken into account. For example, in some embodiments, an SRM molecule may be designed to exhibit a desired redox voltage that is within the upper and lower operating voltages of particular electrochemical cell the SRM is integrated with. Additionally, a concentration of one or more SRMs within an electrochemical cell may be sufficient such that substantially all of a maximum rated charge current density of the electrochemical cell iₘₐₓ is absorbed by the one or more SRMs at a desired upper voltage threshold. It should be understood that the specific shunting voltage and maximum current capability of the one or more SRMs may be controlled by selecting the type and concentration of an SRM to be added to an electrolyte. In addition to the above, in some embodiments, it may also be desirable for the SRM and SRM^{m+} molecules to be soluble and compatible with the particular liquid electrolyte used in an electrochemical cell. Again, depending on the particular embodiment, one or more SRM molecules may be used with electrolytes other than carbonate based electrolytes as the disclosure is not so limited. Each of these concepts is elaborated on further below.

In some embodiments, various organic molecules may be used as an SRM for an electrochemical cell. Further, in at least one embodiment, an organic molecule may be used as an SRM when ionization energy (IE) is comparable, and in some instances equal to, a desired shunting voltage. For example, the oxidization voltage of an SRM may be predicted according to the IE values of molecules in vacuum as a reference. Without wishing to be bound by theory, it is believed that IE may serve as an appropriate basis for the oxidation potential of SRMs in an electrolyte, as it represents the redox potential. The IE values of a molecule may be measured with photoelectron spectroscopy and/or calculated using density functional theory (DFT). This type of process may then be used to build a database of potential SRMs for inclusion in different electrochemical cells to provide different upper current thresholds/shuttling voltages as well as current capacities. Possible SRMs include, but are not limited to: N,N,N′,N′-tetramethyl-pphenylenediamine (TMPD) which has an experimental IE value of 6.75 eV, and a calculated IE value of 5.88 V, which shows an oxidation voltage at 3.3 V; 3,5-dimethylpyrazolate (DMPZ) which exhibits an averaged voltage of 3.29V; naphthalene-2,3-dicarboxaldehyde (NDA) which exhibits an averaged voltage of 3.64V; trimethylamine (TMA) which exhibits an averaged voltage of 3.88V; and p-phenylenediamine (PPD) which exhibits an averaged voltage of 3.93 V. As noted above different SRMs with different shuttling voltages for limiting the upper threshold charging voltage are also contemplated as the disclosure is not so limited.

In view of the above, in some embodiments, an SRM may exhibit an ionization energy that is less than or equal to 7 electron volts (eV), 6.5 eV, 6 eV, 5.5 eV, or any other appropriate energy. Correspondingly, the SRM may have an ionization energy that is greater than or equal to 5 eV, 5.5 eV, 6eV, 6.5 eV, or any other appropriate energy. Combinations of the above ranges are contemplated, including, for example, an SRM with an ionization energy that is between or equal to 5 eV and 7 eV. However, it should be understood that ionization energies both greater than and less than those noted above are also contemplated as the disclosure is not so limited.

As noted above, in some embodiments, an SRM, and the corresponding SRM^{m+}, may be selected such that it is compatible with an electrolyte of an electrochemical cell. For example, if an SRM^{m+} molecule may oxidize the electrolyte if the oxidation potential is too high. Accordingly, in some embodiments, it may be desirable to select an SRM by comparing the relative potentials of the singly occupied molecular orbital (SOMO) energies of the SRM^{m+} molecule with that of the highest occupied molecular orbital (HOMO) energies of the electrolyte. For example, in at least one embodiment, the SOMO energies of the SRM^{m+} may be higher than the HOMO energy of the corresponding electrolyte. Without wishing to be bound by theory, this may reduce, and/or substantially eliminate, SRM^{m+} being reduced to SRM by simultaneously oxidizing the electrolyte which would result in the consumption of SRMs and the decomposition of the electrolyte within the electrochemical cell.

When designing an electrochemical cell to handle a particular current density, the type and concentration of a particular SRM may be taken into account. For example, a charging current of an electrochemical cell may be maintained equal to or less than a maximum current charge density iₘₐₓ. The particular maximum current charge density may be related to an ionization state of each SRM as well as the associated diffusivity of the SRM within the electrolyte. Accordingly, a concentration of SRM within the electrolyte may be selected such that it is capable of absorbing at least the maximum applied current during charging. This condition may be met when the following equation is satisfied:

mF(D⋅cld)≥iₘₐₓ

In the above equation, c is the SRM concentration, m is the ionization state of the individual SRM molecules, F is the Faraday constant, D is diffusivity of the SRM within the electrolyte, and d is the diffusion distance between the electrodes. This equation may be rewritten to provide a relationship between a desired concentration of an SRM within the electrolyte of an electrochemical cell and iₘₐₓ.

c≥iₘₐₓd/mFD

Without wishing to be bound by theory, the above relationship indicates that a concentration of one or more SRMs within the electrolyte may be selected such that the current capable of being transferred between the electrodes by SRM^{m+} molecules may be greater than a maximum charging current of the electrochemical cell. However, it should be understood that embodiments in which a concentration of one or more SRMs within an electrochemical cell is less than the relationship of the above are also contemplated as the disclosure is not so limited.

### Example: Summary

Having described several materials and methods of use above, a specific embodiment of a method for manufacturing a solid oxygen-redox nanocomposite material is disclosed below. First, a mixture of Li₂O₂ and Li₂O is sonicated in ethanol to reduce particle size. The mixture is then added to a solution of CoCl₂ in ethanol. The reactants are mixed in a molar ratio Li₂O₂:Li₂O:CoCl₂ of 1:n:1, wherein n can be varied to alter the weight percentage of solid oxidant (Li₂O) to shell/skeleton (CO₃O₄) in the final fully oxidized product. The value of n is preferably between about 1 and 10, and more preferably between about 4 and 6. The mixture is stirred for between 1 to 3 hours, and then the solids are isolated by filtration and dried under vacuum. Finally, the material is calcined for 1 to 5 hours between about 250° C. and about 350° C. in an O₂-containing atmosphere substantially free of CO₂ and H₂O.

As noted previously, a nanoparticle based solid oxygen-redox material may include a specific embodiment of a Li₂O core and a Co₃O₄ shell/skeleton. The resulting nanocomposite may undergo the following redox reactions when used in electrochemical devices.

Li₂O₂+2Li⁺+2e⁻=2Li₂OU₁⁰=2.86 V (1)

LiO₂+3Li⁺+3e⁻=2Li₂OU₂⁰=2.88 V (2)

The above voltages U₁⁰ and U₂⁰ are calculated from literature values, although nanoscale interfacial energy effects could shift and smear these thermodynamic voltages (U₁⁰, U₂⁰) by tens of millielectron volts. The theoretical capacity of Li₂O/LiO₂ alone is 1341 Ah/kg based on the weight of Li₂O. However, bulk crystalline LiO₂ (Z=−0.5) is unstable at room temperature and can disproportionate to Li₂O₂ (Z=−1) and O₂ (Z=0). Unencapsulated Li₂O (Z=−2) or Li₂O₂ may also directly charge to O₂ without forming LiO₂. O₂ should only be thermodynamically released above U⁰(Li₂O₂↔O₂)=2.96 V or 3.1 V. Therefore, and without wishing to be bound by theory, if reaction (2) above is well catalyzed (e.g., has low over potential) by the Co₃O₄ nanoshells and resulting skeleton, it may be possible to form LiO₂ during charging instead of O₂. The thermodynamic stability of LiO₂ may also be significantly improved by intimate interfacial wetting between core and shell/skeleton, especially when the core particle is nano-sized (<100 nm).

In the fully oxidized form the core material of a Li₂O/Co₃O₄ nanocomposite cathode comprises Li₂O, which can cycle between Li₂O (s)↔Li₂O₂ (s)↔LiO₂ (s) during cycling. The Co₃O₄ skeleton provides structural integrity while the increased transport pathways and catalytic activity reduce the over potential significantly (by a factor of 5, from η>1.2 V to η≈0.24 V) as shown in the examples below. At the relatively narrow voltage range of testing (2.0 to 3.0 V vs. Li/Li⁺), the Co ions in Co₃O₄ remains in the +2 and +3 oxidation state with cycling, although there may be changes in the bonding configuration at the nano-lithia/Co₃O₄ interface. If the oxygen oxidation state reaches Z=0 it may become oxygen gas. By keeping the lowest oxidation state as Z=−0.5, the oxygen atoms remain as condensed matter rather than a gas. Compared to the Z=0↔−2 cycling of the Li-air battery, cycling between Z=−0.5↔−2 loses 25% of the theoretical capacity, but in some embodiments, is still much larger than cation-redox based cathodes (e.g., a LiCoO₂ cathode). The density of a Li₂O/Co₃O₄ cathode (including binder and carbon black, weight ratio of Li₂O/Co₃O₄=67%/33%) slurry exceeded 2.2 g/cm³. The theoretical capacity of a nanocomposite with 67 wt % Li₂O is 1341 Ah/kg×67%=898.5 Ah/kg.

Another specific embodiment of a method for manufacturing a solid oxygen-redox nanocomposite material is disclosed below. First, Li₂O₂ is sonicated to reduce particle size. The Li₂O₂ is then added to a solution of CoCl₂ in ethanol. The mixture is stirred for 1 to 3 hours, and then the solids are isolated by filtration and dried under vacuum to provide B. The powder B is then mixed with Li₂O powder and milled for 0.15 to 2 hours. The weight ratio of B:Li₂O is preferably between about 1:0.5 and 1:3, and more preferably between about 1:1 and 1:2. Finally the material is calcined for 1 to 5 hours at between 250and about 350 ° C. in an O₂-containing atmosphere substantially free of CO₂ and H₂O.

### Example: Synthesis of Li₂O/Co₃O₄ Solid Oxygen-Redox Electroactive Materials

Li₂O/Co₃O₄ nanocomposite particles with three different weight percentages of Li₂O (53% (NC-53), 67% (NC-67), and 78% (NC-78) with percentages given relative to total weight of Li2O+Co3O4) were synthesized by first sonicating in ethanol, with 200 W power for 20 min a mixture of Li2O/LiO2 to reduce particle size. The lithia mixture was then added to a 0.5 M solution of CoCl₂ in ethanol. The mixture was stirred for 2 hours at room temperature. The solids were then isolated by filtration and dried under vacuum at 120° C. The solid material was then calcined in an atmosphere of dry O₂ for 3 hours at 300° C.

### Example: Characterization of Li₂O/Co₃O₄ Composition and Morphology

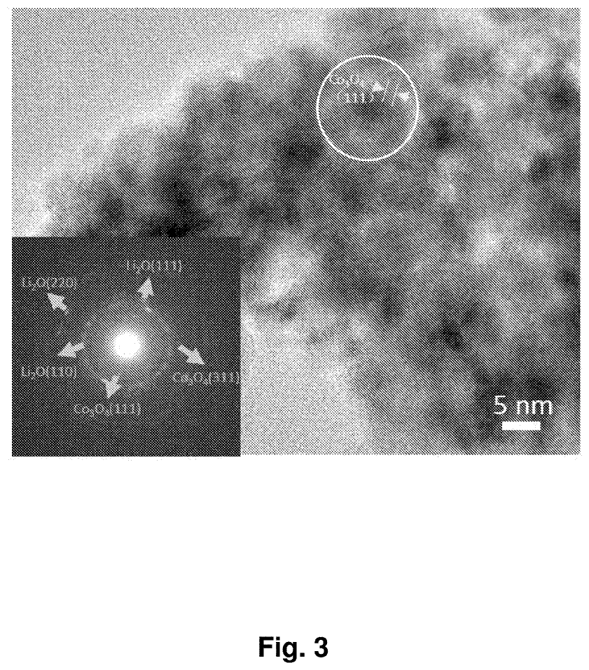

Nanocomposite NC-67 was evaluated by transmission electron microscopy (TEM), and selected-area electron diffraction (SAED). The TEM images in FIG. 3 show that most of the Li₂O nanoparticles are sphere-like with diameters of about 5 nm and are surrounded by a nanocrystalline Co₃O₄ skeleton. The FIG. 3 inset shows the SAED pattern indicating the presence of both Li₂O and Co₃O₄ nanocrystals. A Nanofactory scanning tunneling microscopy (STM)-TEM holder was used in the experiment. The holder was equipped with a 3D piezo-manipulator and biasing capability. The NC-67 cathodes were attached on a tungsten probe using conducting epoxy (Chemtronics CW2400) and mounted on one side of the holder. A tungsten rod was positioned on the other opposing side after scratching a Li metal to transfer a small piece of Li onto the tip. The NC-67 and a piece of Li metal were brought into contact inside the TEM. By applying voltage on the working electrode versus the counter electrode (Li), Li⁺ ions diffused through the oxide/nitride layer. To drive the Li⁺ out from NC-67, 2.95 V was applied to the working electrode with respect to the Li metal. The experiment was performed using a JEOL 2010F TEM operated at 200 kV. The SAED pattern was obtained after 30 min under 2.95 V.

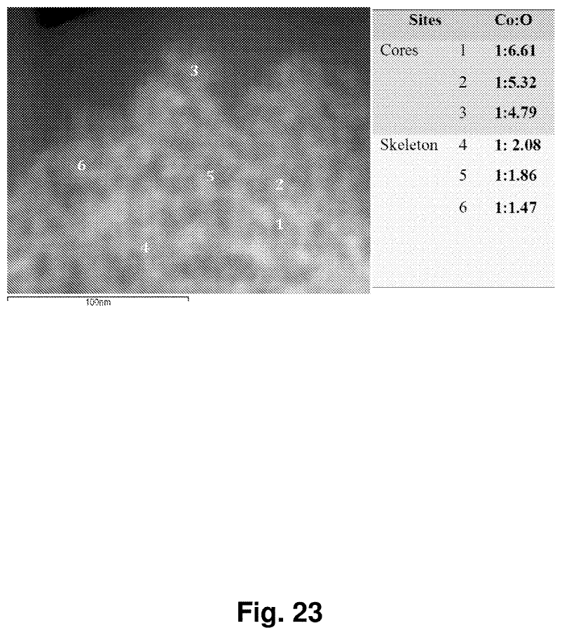

Electron dispersive spectroscopy was used to estimate the Co:O ratio of the cores and the nanoskeleton. FIG. 23 shows the NC-67 material and the Co:O ratios at 3 positions corresponding to cores and 3 positions corresponding to the nanoskeleton. The core Co:O ratio ranges from 1:6.61 to 1:4.79 while the skeleton Co:O ratio ranges from 1:2.08 to 1:1.47, indicating that the cores are mainly Li₂O while the skeleton is mainly Co₃O₄.

### Example: Preparation of a Cathode with Li₂O/Co₃O₄ Nanocomposite

NC-67 (67% w/w Li₂O, 33% w/w Co₃O₄) was mixed with 5% w/w binder and 15% w/w carbon black to form a slurry with overall 54% w/w Li₂O. The slurry was pasted onto an aluminum current collector at a loading of 2 mg/cm².

### Example: Charging and Cycling Performance of Li₂O/Co₃O₄ Nanocomposite

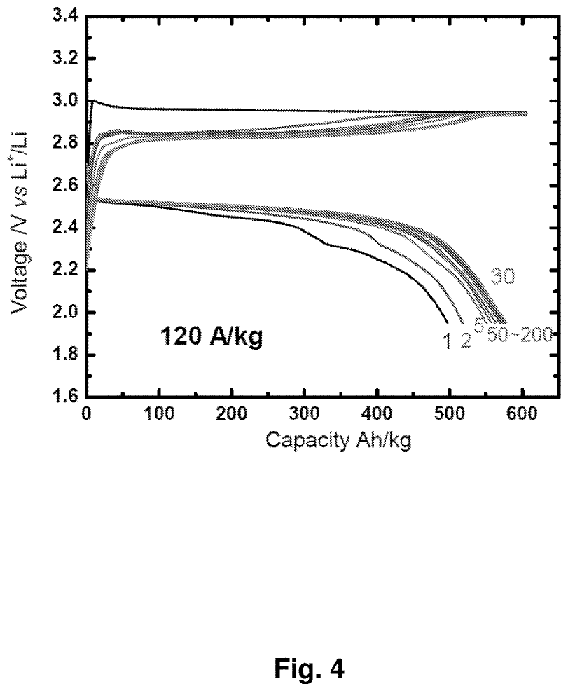

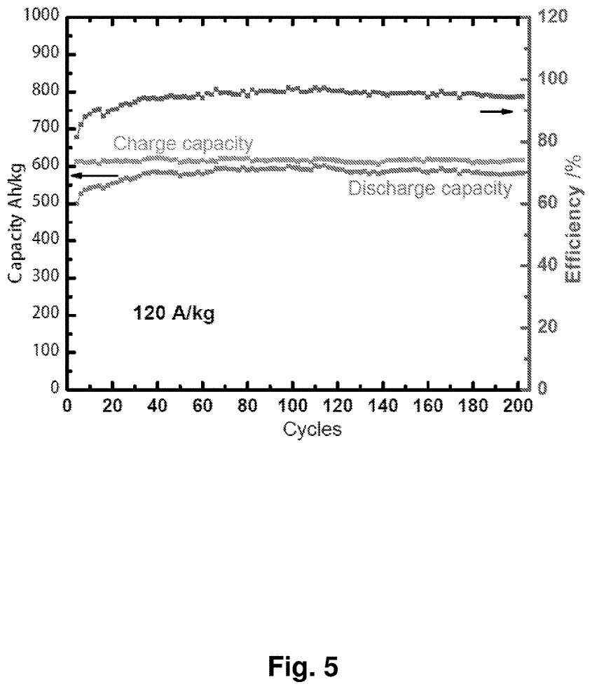

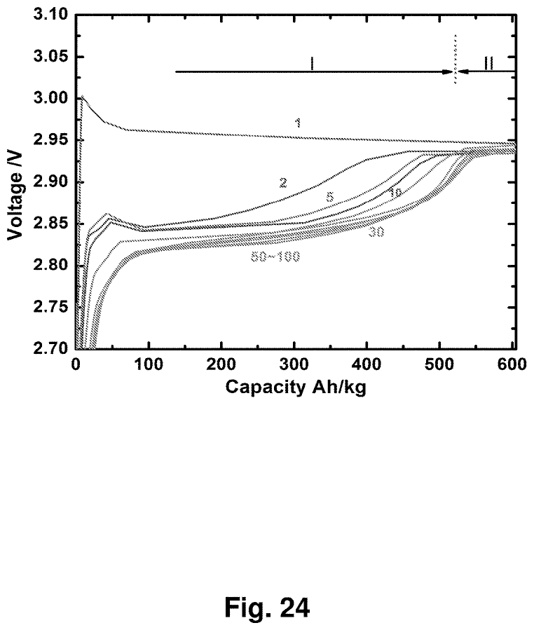

The NC-67 cathode was charged and discharged at constant current of 120 A/kg opposite a Li metal anode. R2032 coin cells were used for the electrochemical tests in this work. Half-cells were fabricated from a cathode of 80% w/w Li₂O and Co₃O₄, 15% w/w C65 conductor, and 5% w/w PVDF; an anode of Li metal sheets; a separator of Celgard 2400 polymer; and a EC/DEC electrolyte. FIG. 4 shows a discharge plateau of about 2.55 V at the current of 120 A/kg, based on Li₂O weight. As shown in FIG. 4 the initial discharge capacity of 502 Ah/kg (based on Li₂O weight) increased to 615 Ah/kg (based on Li₂O weight) after several charge/discharge cycles. A first charge plateau begins at ˜2.8 V and increases gradually to 2.91 V. A second charge plateau is observed above ˜500 Ah/kg at a near constant voltage of about 2.93 V to 2.95 V. A magnified version of the charge curve showing the two plateaus (labeled I & II) is shown in FIG. 24. The first charging cycle shows a high voltage necessary to activate delithiation and lithium ion diffusion pathways from the initially crystalline Li₂O. Lithium diffusion improves over the course of subsequent cycles as the Li₂O/Li₂O₂/LiO₂ material becomes more amorphous. Only 4.9% discharge capacity loss is observed over 200 cycles, and efficiency remains approximately 97% (FIG. 5).

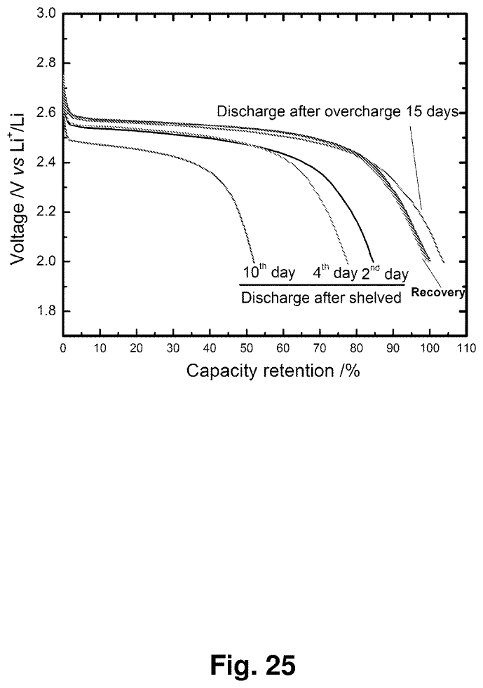

The cathode was also tested for discharge capacity after charging for 15 days (43,200 Ah/kg), after which a 5% increase in first-discharge capacity was observed relative to immediate discharge (FIG. 25). Also shown in FIG. 25, storage of the charged cathode decreased the available discharge capacity (e.g., to 50% after 10 days), but the capacity could be recovered to 100% after subsequent cycling, suggesting the new battery chemistry (e.g., with solvated shuttling species in carbonate electrolyte for voltage shunting) does not have significant corrosive effects, and does not imparts permanent damage to the electrochemical system.

### Example: Gas Detection During Charging of Li₂O/Co₃O₄ Cathode

A self-made quantitative in situ differential electrochemical mass spectrometry (DEMS) was used to detect and analyze gas evolution during the cell testing. Two glued PEEK capillary tubes were used to inlet and outlet gas. The cell was fabricated in a glove box where O₂<0.1 ppm. Then, the output tube was connected to a commercial Thermo mass spectrometer (MS). High purity Ar gas was used as the carrier gas with a flow rate of 3 mL/min during the cycling process. In the constant current charge/discharge process, charge/discharge currents were 100 mA/g, and MS spectra were collected every minute. In the cyclic voltammetry process, the scan rate was 0.05 mV/s, and MS spectra were collected every 20 seconds.

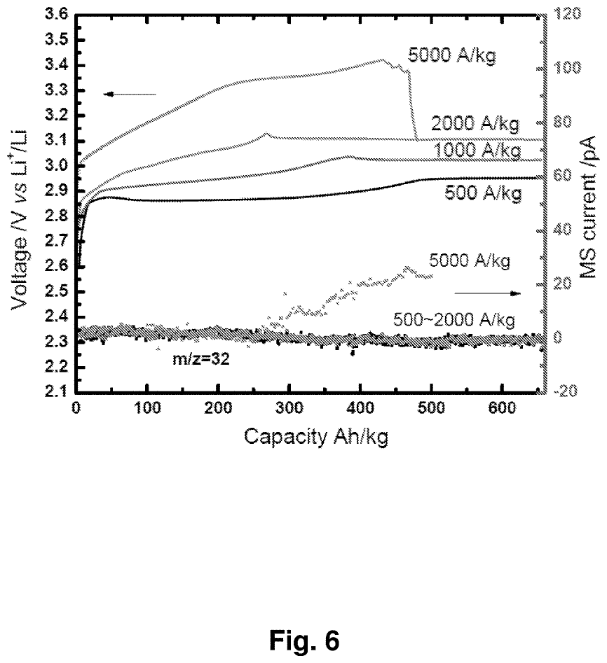

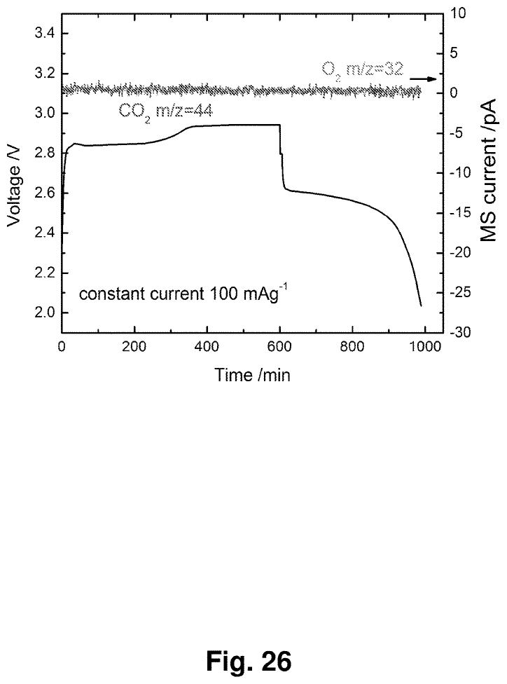

The NC-67 cathode showed no O₂ or CO₂ gas generation when charged at a constant current of 100 A/kg (maximum voltage of 2.95 V) as detected by DEMS (FIG. 26), and by detection with a total gas pressure sensor. As shown in FIG. 6, at higher charging currents O₂ was not detected for currents of 500 A/kg (Vₘₐₓ=2.96 V), 1000 A/kg (Vₘₐₓ=3.04 V), or 2000 A/kg (Vₘₐₓ=3.14 V). At a current of 5000 A/kg O₂ gas evolution was detected when the charge capacity reached Ah/kg at voltages around 3.4 V (FIG. 6). The shuttling mechanism prevents O₂ (Z=0) evolution completely and indefinitely, unless the current capacity of the electrolyte shuttle to carry the current is exceeded. DEMS gas detection during a cyclic voltammetry experiment showed no gas evolution until the voltage was taken above 3.11 V, as seen in FIG. 26.

### Example: Cyclic Voltammetry of a Li₂O/Co₁O₄ Cathode

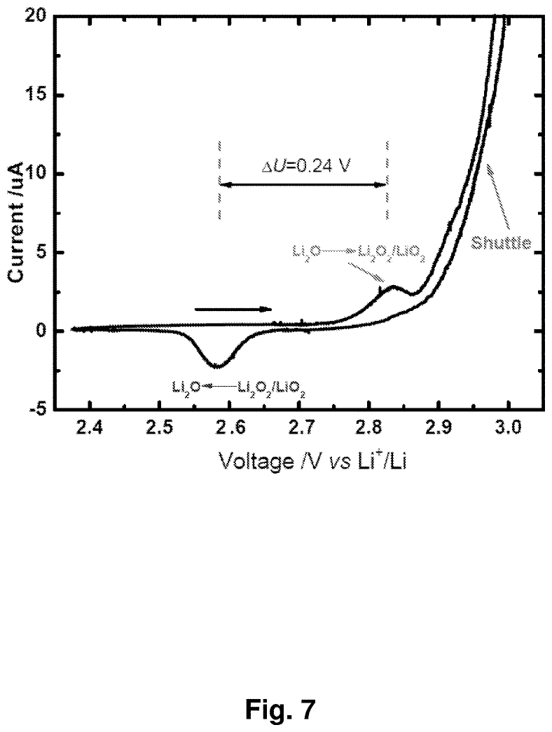

An electrochemical workstation (Gamry Instr, Reference 3000) was used for the CV scanning. FIG. 7 shows a CV at a scan rate of 0.05 mV/s, with a potential gap (ΔU) between oxidation peaks (2.82 V) and reduction (2.58 V) of only 0.24 V, which is only one-fifth of the over potential loss observed in Li-air batteries. The oxidation peak at 2.82 V is more than a full volt lower than the charge plateau observed in Li-air of more than 4.0 V.

### Example: Characterizations of Li₂O/Co₃O₄ Cathode During and After Charging

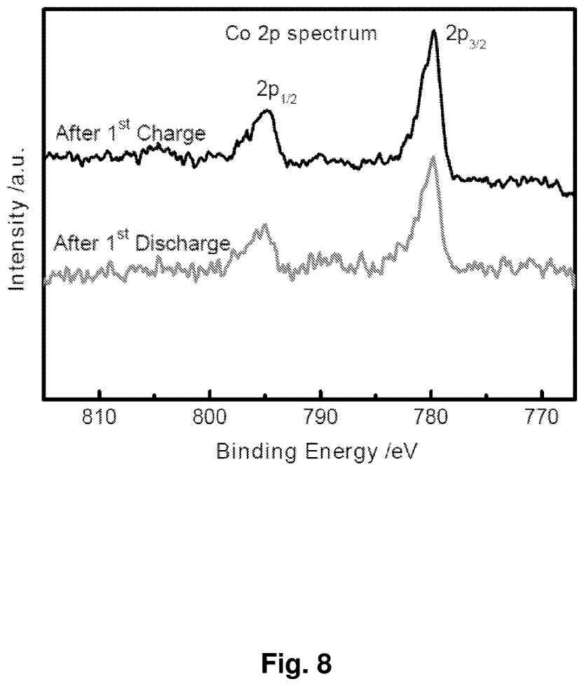

X-ray photoelectron spectra (XPS) after the first charge and discharge are presented in FIG. 8. The two peaks at ˜795 eV (Co 2p_{1/2}) and ˜780 eV (Co 2p_{3/2}) confirm that the composition of cobalt oxide is Co₃O₄, in agreement with TEM/SAED results. The peak positions of Co 2p_{1/2,3/2} are unchanged during electrochemical cycling, thus cobalt ions supply negligible redox reactions in accounting for the electrochemical activity of the cathode. This finding also agrees with the notion that at the voltage range of testing (2-3 V vs Li/Li⁺), the Co ions in Co₃O₄ are electrochemically inactive and should remain in the +2 and +3 oxidation state (note when Co₃O₄ is itself used as an anode the active voltage is below 1.2 V vs Li/Li⁺).

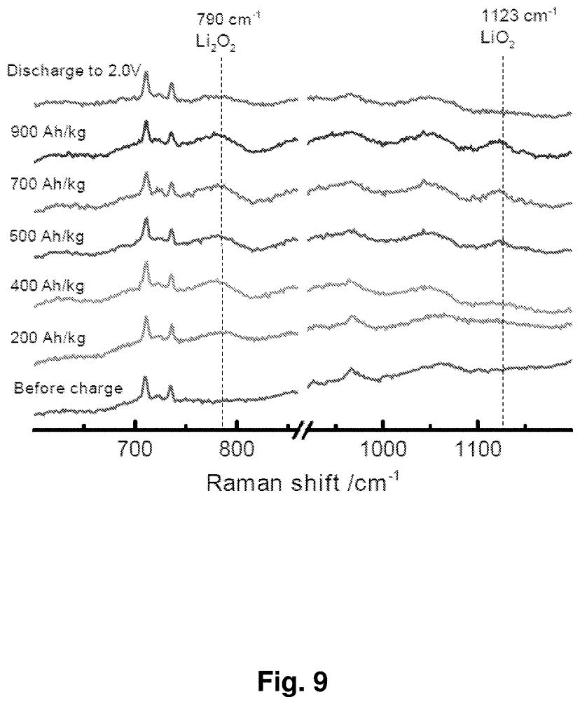

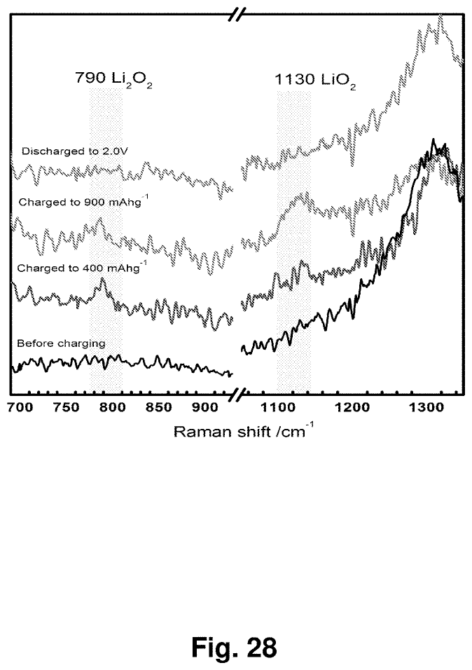

In situ Raman spectroscopy during cycling (FIG. 9) shows a new peak at 780-800 cm⁻¹ when the cathode is charged to 200 Ah/kg, consistent with the 790 cm⁻¹ band of Li₂O₂. The peak grows taller at 400 Ah/kg but remains nearly constant at higher capacity. A new Raman peak between 1100 cm⁻¹ and 1150 cm⁻¹ emerged when the capacity reached 500 Ah/kg and grew stronger at 700 Ah/kg (FIG. 9). This peak is similar to the 1123 cm⁻¹ peak reported for the O₂⁻ anion (Z=−0.5), although not as sharp, suggesting some form of amorphous LiO₂ (solid) is generated. When the cathode was finally discharged to 2.0 V, the intensity was very weak at 780-800 cm⁻¹ (Li₂O₂ (solid)) and totally disappeared at 1110-1140 cm⁻¹ (LiO₂ (solid)). Because superoxide O₂⁻ (Z=−0.5) species can exist either in confined amorphous solid or solvated in the liquid electrolyte, the cell was opened at different states of charge (SOCs), the cathode was thoroughly washed with dimethoxyethane (DME) to remove the original electrolyte and solvated ions, and Raman performed on the washed cathode. The Raman spectra of the thoroughly washed cathode at different SOCs still showed similar peaks at ˜790 cm⁻¹ and ˜1130 cm⁻¹ (FIG. 28), indicating Li₂O₂ and LiO₂ are present as parts of the solid electrode. The Raman spectra were measured using a Horiba Jobin-Yvon HR800 Raman spectrometer with a 633 nm laser.

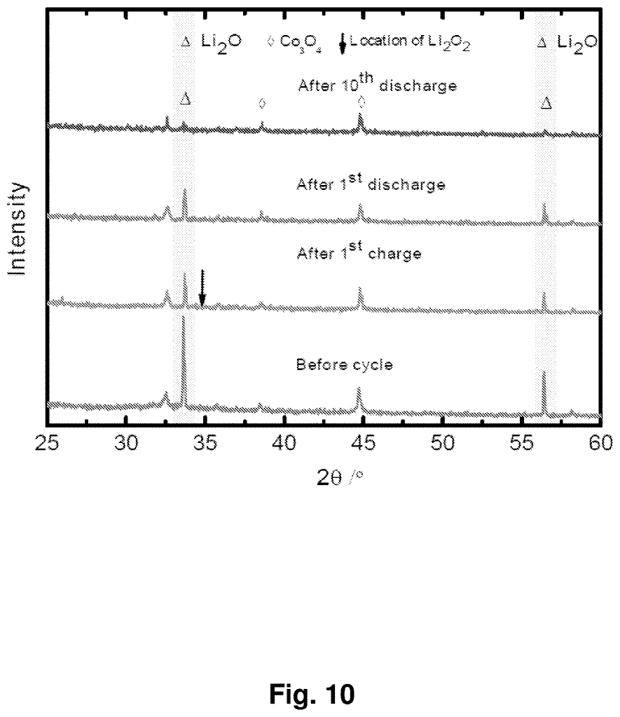

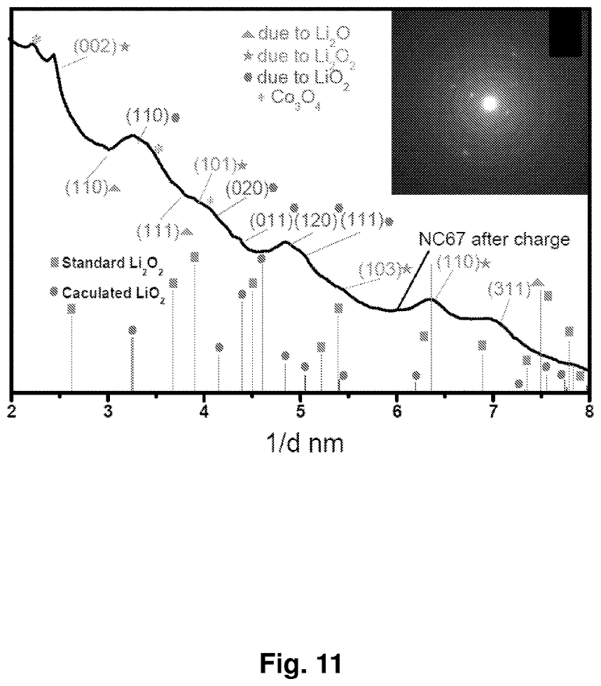

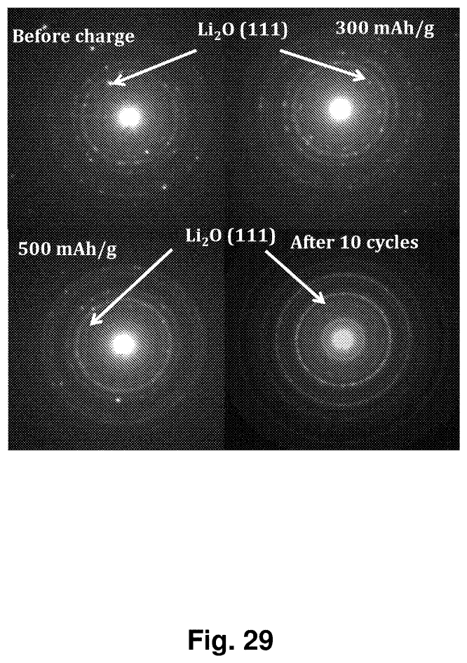

In situ X-ray diffraction (XRD) and SAED were used to investigate the variation in the NC-67 structure during battery cycling. XRD measurements were carried out via a Bruker D8-Advance diffractometer using Cu Ka radiation, at 100 mA and 40 kV. The sample was scanned from 10° to 90° at a speed of 4° per minute. FIG. 10 shows the XRD curves of the cathode at different charge/discharge states and cycles. The original peaks of the Li₂O crystal decreased significantly after the first charge, did not recover in the following discharge, and almost disappeared after 10 cycles. While no obvious peaks corresponding to Li₂O₂ (arrow locations) or LiO₂ crystals were observed in the XRD, SAED (FIG. 11) showed low-index planes of the crystalline motif (such as (002), (101), (103) and (110) of crystalline Li₂O₂, and (110), (020), (011), (120) and (111) of crystalline LiO₂) in the charged product, even though many high-index planes did not match. The XRD and SAED results suggest that most of the nano-lithia turned into an amorphous Li₂O/Li₂O₂/LiO₂ mixture in 10 cycles (FIG. 29).

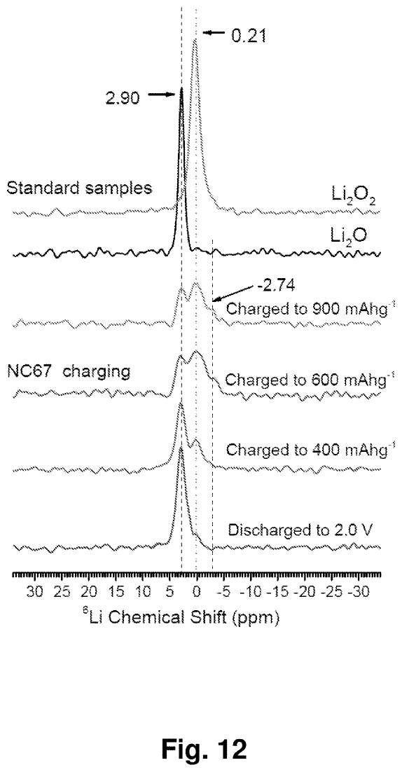

⁶Li NMR on the post-DME-washed cathode at different SOCs (all referenced to 1 M LiCl solution) are shown together with lithium oxide and lithium peroxide standards, in FIG. 12. A 600 MHz Bruker NMR solid spectrometer was used to obtain ⁶Li NMR with a main magnetic field of 14.1 T and a ⁶Li Lamor frequency of 88.34 MHz. The rotors containing the samples were spinning at a rate of ˜10 kHz at room temperature to acquire the NMR spectra. The reference Li₂O and Li₂O₂ crystals have a sharp peak at 2.90 ppm and 0.21 ppm, respectively. The discharged NC-67 cathode has a strong peak at 2.90 ppm and a small peak at 0.21 ppm, indicating that the major component at this state is Li₂O, with a small amount of Li₂O₂. When charged to 400 Ah/kg, an obvious 0.21 ppm peak emerged, indicating that a significant amount of Li₂O₂ formed. When further charged to 600 Ah/kg and 900 Ah/kg, the peak at 0.21 ppm became taller than that at 2.90 ppm, and another peak appeared at −2.74 ppm (FIG. 12), for which no report was found in the literature.

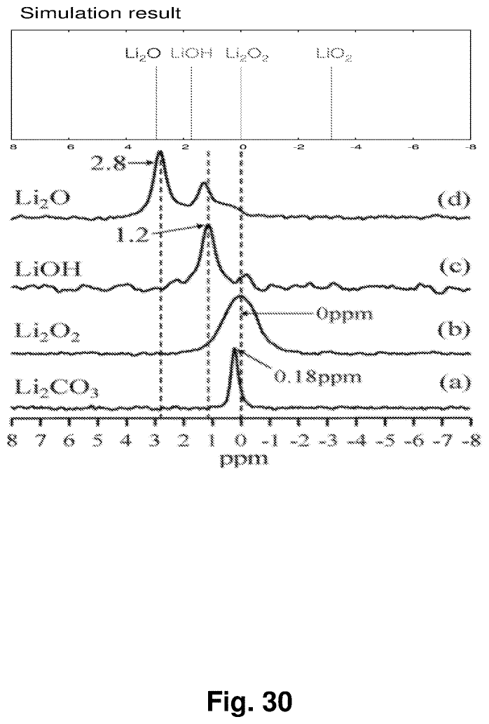

The calculated chemical shift for different Li—O crystals using density functional theory (DFT) with the Vienna Ab initio Simulation Package are shown in FIG. 30. The chemical shifts were calculated using Vienna Ab Initio Simulation Package (VASP) with a plane wave basis and projected-augmented wave (PAW) potentials. Exchange-correlation functionals used in the calculation were of a Perdew-Berke-Ernzerhof (PBE) form within the generalized-gradient approximation (GGA). The simulation cells for Li₂O, Li₂O₂, and LiO₂ consisted of 8 Li and 4 O atoms, 4 Li and 4 Li atoms, and 2 Li and 4 O atoms, respectively. After the cell parameters and the atom positions were optimized by conjugate gradient energy minimization, the chemical shifts were calculated using the linear response method. The calculated chemical shift values were shifted to match the experimentally obtained NMR chemical shift value of Li₂O₂. An energy cutoff of 450 eV was used for the structural optimization and 580 eV was used for the chemical shift calculation. Monkhorst-Pack k-point sampling of 5×5×5, 8×8×4, and 6×6×3 were selected for Li₂O, Li₂O₂, and LiO₂, respectively. FIG. 30 shows calculated chemical shifts in comparison with the experiments. The calculated values are shifted to match the experimentally obtained NMR peak of Li₂O₂. The simulation results were benchmarked to an experimental data reported in J. Xiao et al., J. Power Sources, 196 (2011) 5674-5678. The calculated chemical shifts for Li₂O, LiOH, and Li₂O₂ match well with the reference, and the simulated value for LiO₂ appears on the negative side and easily distinguished from the others. The calculated chemical shift for LiO₂ is −3.1 ppm vs Li₂O₂, or −2.9 ppm versus 1 M LiCl solution as used in the experiment, matching very well with the experimental value of −2.74 ppm (FIG. 12). The NMR measurements together with the DFT calculation support the presence of LiO₂ in a deeply charged NC-67 electrode after washing.

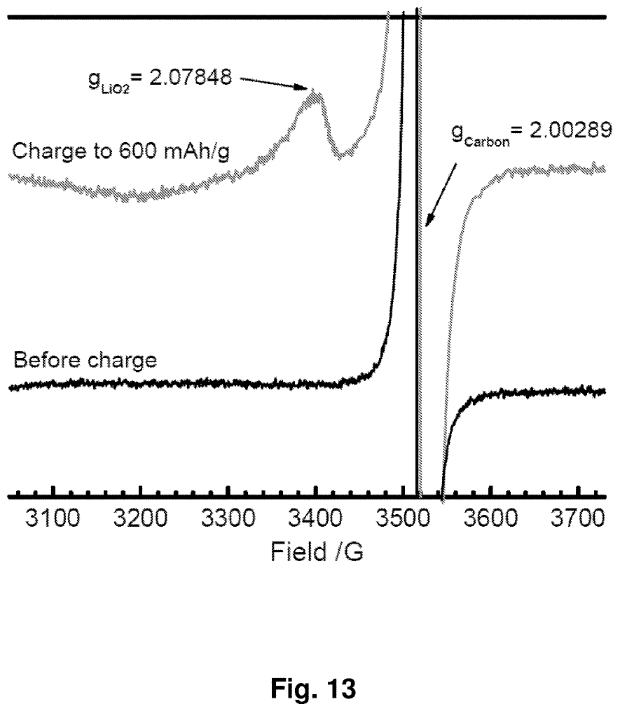

FIG. 13 shows the electron spin resonance (ESR) spectra for the NC-67 cathode at 70 K, before and after charging. It shows only an electron spin signal (g=2.00289) from carbon before charge, indicating no other elements containing a single electron. However, another peak with g=2.07848 appeared after charging. This peak is due to the single-electron spin of the superoxide (O₂⁻). The measured g-factor is between the ab initio calculated values for orthorhombic bulk LiO₂ (g=2.085) and molecular LiO₂ (g=2.045), and is closer to the former, which is consistent with the nanoscale amorphous structure of the LiO₂ component in the NC-67 material. A Bruker EMX ESR spectrometer with an ER 4199HS cavity and a Gunn diode microwave source producing X-band (9.859 GHz, ≈0.2 mW) radiation was used. The magnetic field modulation was 100 kHz and the modulation amplitude was 1 G. The scan rates were 0.5 G/s with a time constant of 0.2 s.

### Example: Characterization of Electrolyte Shuttling Mechanism

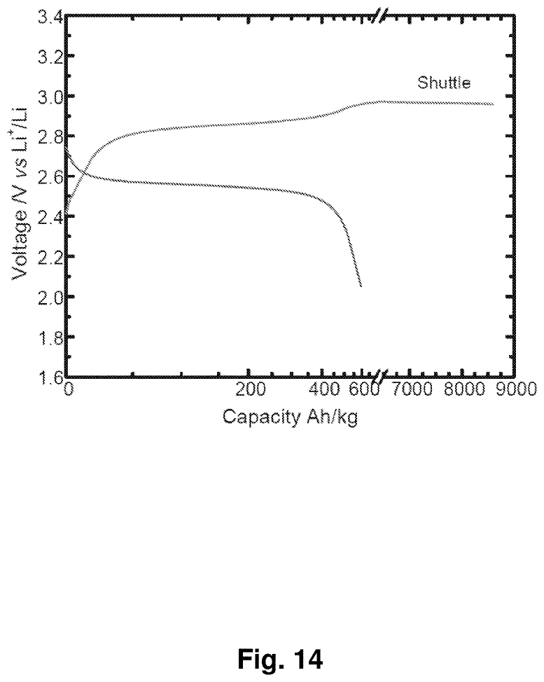

On the charging curve in FIG. 4, the voltage was constant at ˜2.95 V under 120 A/kg at the end of charge (second charge plateau). To test the endurance of the plateau, galvanostatic charging at 120 A/kg for 72 hours was performed, and the voltage did not exceed 2.95 V (FIG. 14). Upon the first discharge, the discharge capacity did not change, indicating no damage to the battery. The preserved discharge capacity would not be observed if there had been an irreversible side reaction or oxygen release or any form of permanent damage during the 3-day overcharging. This shunting of potential has not been observed in the Li-air battery, but can be understood as shuttling of a soluble A/A⁻ species as depicted in FIGS. 15 and 16.

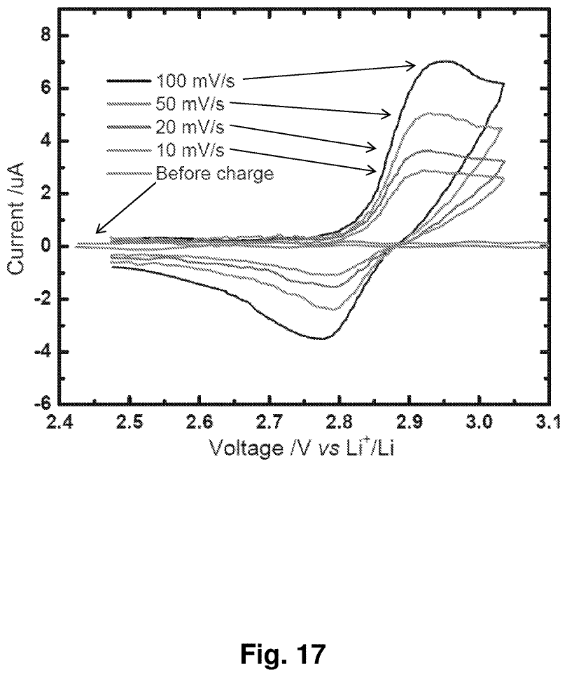

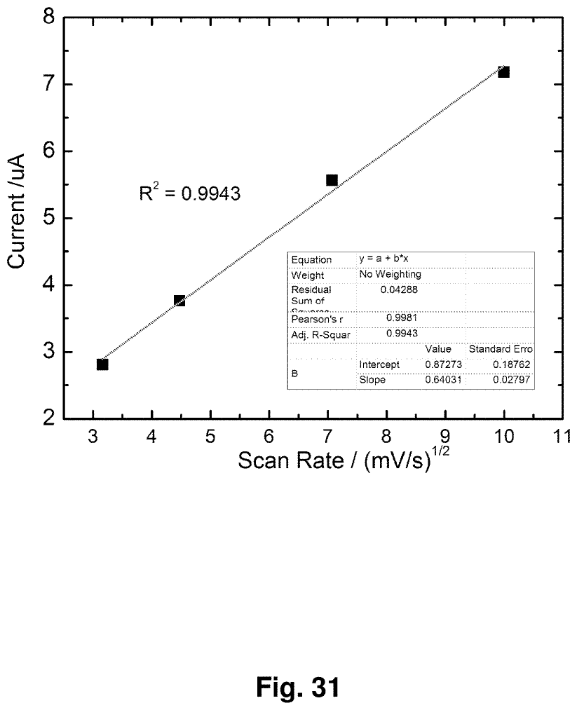

To investigate the shuttling species more deeply, a fully charged cell was disassembled and the electrolyte was carefully collected by thoroughly washing the cathode foil, membrane, anode, and internal cavity of the cell with EC/DEC (1:1 by volume). The diluted electrolyte was investigated by CV at different scanning rates in a Pt/Li/Li three-electrode system. The CVs of both the original electrolyte and the collected diluted electrolyte after charging are shown in FIG. 17. The CV curves indicate that the fresh electrolyte has no redox peaks, consistent with the expectation that EC/DEC is electrochemically stable between 2.4 V and 3.1 V. However, the CV of the charged electrolyte shows classical redox behavior, with an oxidation peak of 2.91-2.95 V and reduction peak of 2.76-2.79 V. Additionally, as shown in FIG. 31, the oxidation peak current (iₚ) and the square root of the scanning rate (ν^{1/2}) show a linear relationship (R²=0.9943), indicating diffusion control and further corroborating the existence of soluble redox couple in the electrolyte that physically supports the shuttling process, which protects the solid oxygen-redox electrode from O₂ gas evolution no matter how long the electrode is charged.

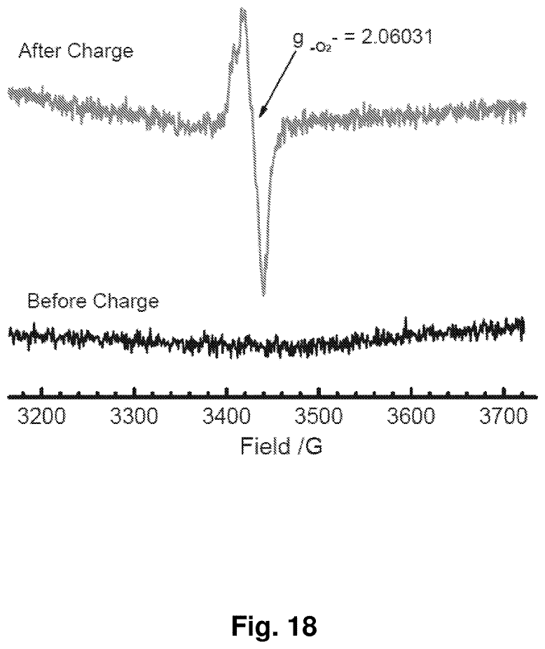

In situ ESR was performed to detect the shuttling species in the electrolyte at the end of charge, and the result is shown in FIG. 18. The ESR of electrolyte indicated no spin signal in the before charge sample, but an obvious radical signal at g=2.06031 after charge. This g-factor is between the ab initio calculated values for orthorhombic bulk LiO₂ (g=2.085) and molecular LiO₂ (g=2.045), but is closer to the latter. This supports that the organic superoxide radical coordinated with the solvent molecules acted as the shuttling species in the electrolyte at the end of charge, as illustrated in FIGS. 15 and 16. A Bruker EMX ESR spectrometer with an ER 4199HS cavity and a Gunn diode microwave source producing X-band (9.859 GHz, ≈0.2 mW) radiation was used. The magnetic field modulation was 100 kHz and the modulation amplitude was 1 G. The scan rates were 0.5 G/s with a time constant of 0.2 s.

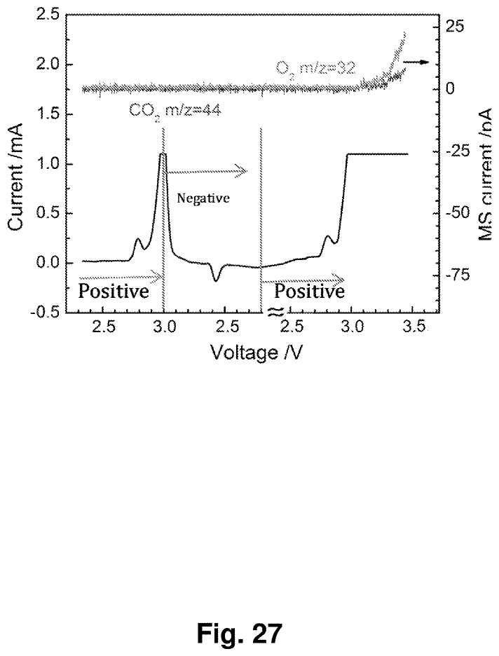

The automatic overcharge protection mechanism also explains why the cheap and common carbonate electrolytes can be used in sealed cells, whereas they perform very badly in the Li-air battery. In CV tests with different voltage windows, DEMS analysis showed that CO₂ gas evolved only after the generation of O₂ gas when the voltage reached higher than 3.11 V (FIG. 27). Thus, the decomposition of EC electrolyte to CO₂ would occur only after O₂ (Z=0) was present. But with automatic voltage shunting to below 2.95 V, the Z of the solvated superoxide radical remains less or equal to Z=−0.5 in the O₂-free condition, and the carbonate electrolytes maintain their chemical stability and do not decompose into CO₂ gas.

### Example: Battery Performance with Li₂O/Co₃O₄ Cathode

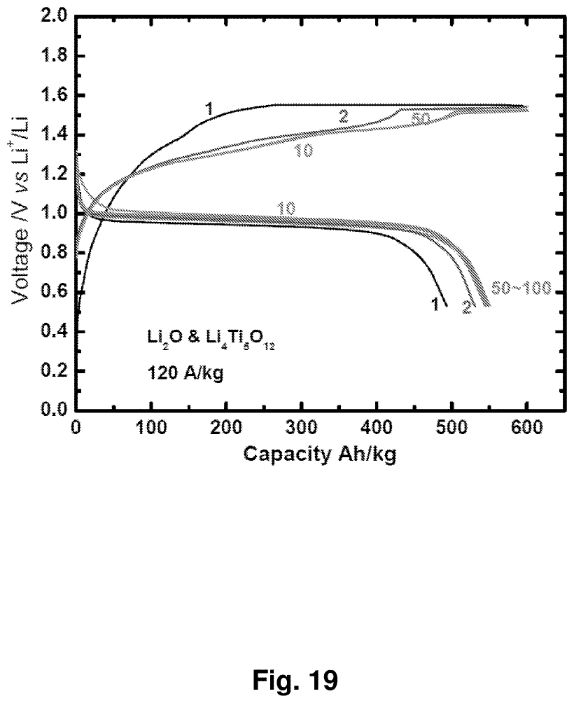

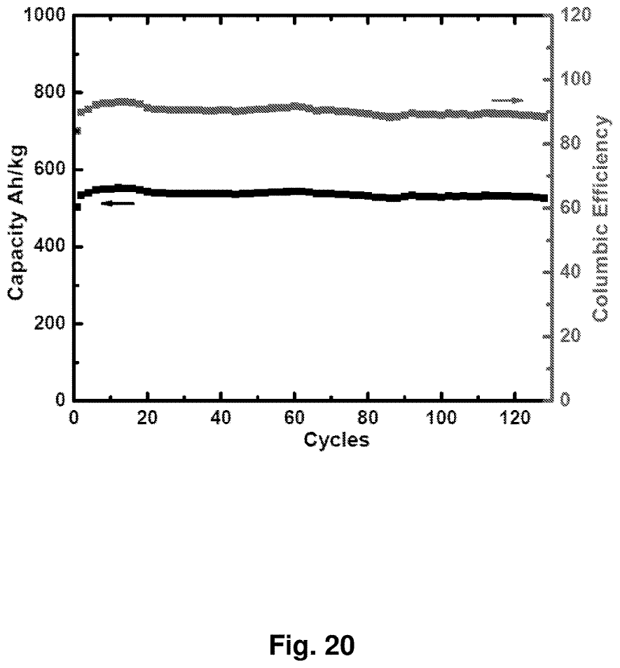

A lithium-matched full cell was assembled using NC-67 as cathode. Li₄Ti₅O₁₂ was used as the anode with 15% w/w C65 as conductive agent and 5% w/w PVDF as binder. The electrolyte solution was 1 M LiPF₆ dissolved in a mixture of EC and DEC with a volume ratio of 1:1, and 2% w/w vinylene carbonate additive. A LAND CT2001A 8-channel automatic battery test system (Wuhan Lanhe Electronics Co., Ltd., China) was used for charging/discharging of the cells. The Li capacity for Li₄Ti₅O₁₂→Li₇Ti₅O₁₂ was 110% of the NC-67 cathode capacity (measured previously with a half-cell employing a superabundant amount of lithium metal). As shown FIGS. 19 and 20, the NC-67/Li₄Ti₅O₁₂ lithium-matched full cell had a capacity of 549 Ah/kg at a loading of 2 mg/cm², with capacity loss of only 1.8% after 130 cycles (compared to 4.9% with Li metal anode). This lithium-matched full-cell test indicated that even if a solid-electrolyte interphase (SEI) layer formed on the cathode surface, it is stable during cycling, despite the necessarily large volume change of nano-lithia Li₂O/Li₂O₂/LiO₂ (s).

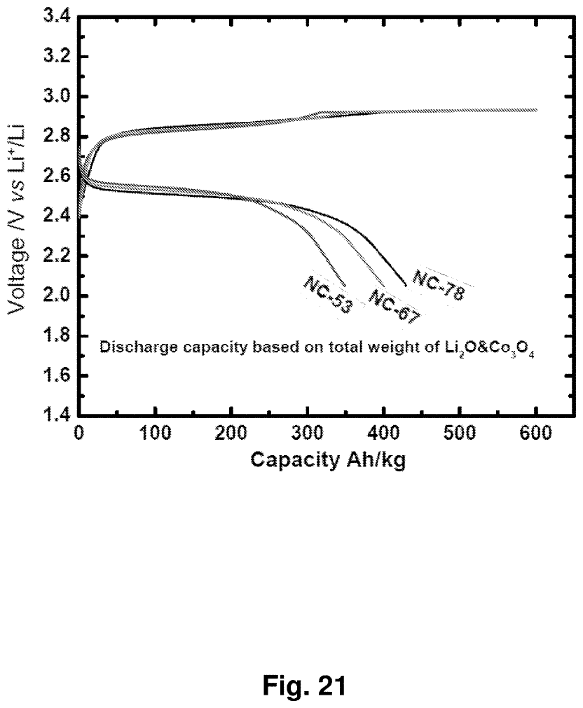

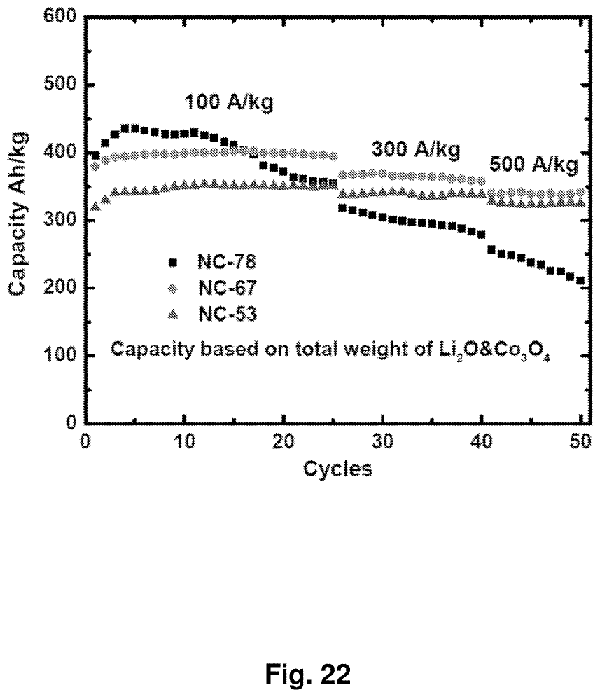

Additionally, the Co₃O₄ weight fraction was varied for three NC cathodes (NC-53, -67, and -78, which were loaded with 53%, 67%, and 78% w/w Li₂O, respectively, with the balance Co₃O₄) to compare the discharge capacity and rate performance. The voltage profiles of each sample and the rate performance are shown in FIGS. 21 and 22. All of the samples were charged to 600 Ah/kg based on Li₂O. The discharge capacity was 349.8 Ah/kg, 400.7 Ah/kg, and 429.8 Ah/kg for NC-53, -67, and -78 under 100 A/kg constant current. (The gravimetric current and capacities reported above are based on the total weight of Li₂O and Co₃O₄) The percentages of actual capacity to theoretical capacity of the three samples were 49.1%, 44.5%, and 41.0%, respectively. That is, although the overall capacity of the electroactive material increased with the increasing content of Li₂O, the efficiency of utilizing Li₂O decreased, as well as the cyclability and rate performance (FIG. 22).

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

1. An electroactive nanocomposite material comprising:
an electroactive core comprising at least one of an alkali metal oxide, peroxide, or superoxide, or an alkaline earth metal oxide, peroxide, or superoxide; and
a nanoshell or skeleton surrounding the core.

2. The electroactive material of claim 1, wherein the core comprises an alkali metal oxide.

3. The electroactive material of claim 2, wherein the core comprises at least one of lithium oxide, lithium peroxide, and lithium superoxide.

4. The electroactive material of any one of claims 1, wherein the nanoshell or skeleton comprises a transition metal oxide or a metal.

5. The electroactive material of claim 4, wherein the nanoshell or skeleton comprises cobalt oxide.

6. The electroactive material of any one of claims 1, wherein the nanoshell or skeleton is permeable to lithium ions and conductive to electrons.

7. The electroactive material of any one of claims 1, wherein the core accounts for between 50% and 90% of the weight of the electroactive material.

8. The electroactive material of claim 7, wherein the core accounts for between 60% and 70% of the weight of the electroactive material.

9. The electroactive material of any one of claims 1, wherein the core has an average maximum particle dimension between 2 nm and 20 nm.

10. The electroactive material of claim 9, wherein the core has an average maximum particle dimension between 5 nm and 10 nm.

11. The electroactive material of any one of claims 1, wherein the nanoshell or skeleton has an average thickness of between 2 nm and 10 nm.

12. A method of preparing an electroactive nanocomposite material, the method comprising:
placing core particles in a solvent, wherein the core particles comprise at least one of an alkali metal oxide, peroxide, or superoxide, or an alkaline earth metal oxide, peroxide, or superoxide;
placing a transition metal salt in the solvent; and
precipitating a nanoshell or skeleton comprising a transition metal onto the particles to form a nanocomposite.

13. The method of claim 12, wherein the core particles comprise an alkali metal oxide.

14. The method of claim 13, wherein the core particles comprise lithium oxide or lithium peroxide.

15. The method of any one of claims 12, wherein the metal salt is a transition metal halide, nitrate or sulfate.

16. The method of claim 15, wherein the metal salt is cobalt chloride.

17. The method of any one of claims 12, wherein the particles have an average maximum particle dimension between 2 nm and 20 nm.

18. The method of any one of claims 12, wherein the step of precipitating is performed for a duration sufficient to form a nanoshell or skeleton with an average thickness between 2 nm and 10 nm.

19. The method of any one of claims 12, further comprising drying the core particles.

20. The method of any one of claims 12, further comprising calcining the nanocomposite in an atmosphere comprising oxygen.

21. The method of any one of claims 12, wherein the step of calcining is performed at a temperature between 250° C. and 350° C.

22. The method of any one of claims 12, further comprising sonicating the core particles.

23. The method of claim 22, wherein the energy and duration of sonication are sufficient to break up core particles having a first average maximum particle dimension to form core particles having a smaller second average maximum particle dimension.

24. The method of claim 23, wherein the second average maximum particle dimension is between 2 and 20 nm.

25. The method of any one of claims 12, further comprising annealing the nanocomposite.

26. A sealed electrochemical device comprising:
a cathode;
an anode; and
an electrolyte, wherein the cathode comprises an electroactive nanocomposite material of any one of claims 1-12.

27. The electrochemical device of claim 26, wherein the electrolyte comprises a carbonate.

28. The electrochemical device of claim 27, wherein the electrolyte comprises ethylene carbonate, propylene carbonate, dimethyl carbonate, diethyl carbonate, ethyl methyl carbonate, vinylene carbonate or fluoroethylene carbonate.
